(19) United States
(12) Patent Application Publication
(10) Pub. No.: US 2025/0232543 A1
(43) Pub. Date: Jul. 17, 2025

(54) SYSTEMS AND METHODS FOR ENHANCED VIRTUAL REALITY INTERACTIONS

(71) Applicant: State Farm Mutual Automobile Insurance Company, Bloomington, IL (US)

(72) Inventors: Veena Vivek, Chandler, AZ (US); Jody A. Thoele, Bloomington, IL (US); Brian Fields, Phoenix, AZ (US); Antonio Cunanan, Richardson, TX (US); Fizza Mahdi, Murphy, TX (US)

(21) Appl. No.: 19/017,000

(22) Filed: Jan. 10, 2025

Related U.S. Application Data
(60) Provisional application No. 63/621,945, filed on Jan. 17, 2024.
(60) Provisional application No. 63/626,342, filed on Jan. 29, 2024.
(60) Provisional application No. 63/549,046, filed on Feb. 2, 2024.

(51) Int. Cl. G06T 19/20; G06T 13/40; G06T 19/00

(52) U.S. Cl. CPC G06T 19/20; G06T 13/40; G06T 19/003; G06T 2219/2004; G06T 2219/2016

(57) ABSTRACT

A computer system is provided. The computer system may be configured or programmed to: (1) communicate with a user device to cause the user device to present a virtual environment, the virtual environment including at least one agent avatar associated with an agent; (2) receive, from the user device, user input data including one or more of live audio data, live video data, or live motion data; (3) generate a proposed response based upon the user input data; (4) determine whether an agent is present at an agent interface; (5) when the agent is present at the agent interface, cause the agent interface to display a recommendation including the proposed response; and/or (6) when the agent is not present at the agent interface, cause that at least one agent avatar to perform the proposed response within the virtual environment.

### CROSS-REFERENCE TO RELATED APPLICATIONS

This application claims the benefit of priority to U.S. Provisional Application No. 63/621,945, filed Jan. 17, 2024, and entitled “SYSTEMS AND METHODS FOR ENHANCED VIRTUAL REALITY INTERACTIONS,” U.S. Provisional Application No. 63/626,342, filed Jan. 29, 2024, and entitled “SYSTEMS AND METHODS FOR ENHANCED VIRTUAL REALITY INTERACTIONS,” and U.S. Provisional Patent Application No. 63/549,046, filed Feb. 2, 2024, and entitled “SYSTEMS AND METHODS FOR ENHANCED VIRTUAL REALITY INTERACTIONS,” the contents and disclosures of which are hereby incorporated herein by reference in their entirety.

### FIELD OF DISCLOSURE

The present disclosure relates to enhanced virtual reality interactions and, more particularly, to network-based systems and methods for generating a virtual reality environment and facilitating an exchange of information through the virtual reality environment.

### BACKGROUND

The metaverse is designed for millions of users to interact with each other at any moment in time, as well as 24 hours a day, 7 days a week, all of the time. Since the metaverse is a hosted virtual reality, individual users may desire to interact with other individuals through an avatar, both real and fictional. However, live individuals, either as an avatar or as a live person, may only be able to interact with one or a few users at a time and would not be available all of the time.

In the metaverse, it is also desirable to increase trust and confidence of the user in the individuals interacting with the user within the metaverse, and for the individuals to appropriately respond to any questions, statements, gestures, or an emotional state of the user displayed within the metaverse. Known virtual reality computer systems are unable to provide this type of increased trust and confidence between users interacting within the metaverse. Conventional techniques may include additional inefficiencies, encumbrances, ineffectiveness, and/or other drawbacks as well.

### BRIEF SUMMARY

The present embodiments may relate to, inter alia, systems and methods for enhanced virtual reality interaction. In the exemplary embodiment, the systems and methods may generate a VR environment that includes one or more avatars and one or more virtual locations that may be visited by a user avatar controlled by a user with a user device (e.g., an AR or VR headset and/or other AR or VR system). These virtual locations may include places of business, such as insurance agencies, having real-world counterparts, and may be occupied by user avatars (e.g., if the agent is available live) and/or avatars associated with a replica persona of the agent (e.g., if the agent is not available live). By visiting the locations virtually, the user may purchase products or obtain information about the business, for example, by viewing overlays or aspects of the VR environment itself (e.g., virtual signage or documents included in the VR environment) and/or by interacting with an avatar associated with the corresponding agent (e.g., by asking questions and receiving responses from the agent or the agent's virtual replicant). By visiting and interview agents in a virtual setting, the user does not need to physically travel to interact with different agents, therefore making it easier for users in remote locations to interact with one or more agents, and also making it easier for users to identify an agent having attributes (e.g., background, affinity, demographics, technical skills, language skills, experience, education, hobbies, etc.) compatible with or considered desirable by the user. For example, by visiting one or more virtual locations, users can get to know different agents by interviewing and/or viewing information (e.g., introductory videos) relating to the agent. Additionally, data provided by the user or agent may be recorded and stored in a database, so that the data may be retrieved seamlessly for future interactions within the VR environment and for traditional interactions outside of the VR environment. For example, records of interactions within the virtual environment may be used to process any transactions that may have occurred within the virtual environment.

In one aspect, a computer system for generating a virtual reality replicant persona for interaction with at least one user may be provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT or ChatGPT-based bots, and/or other electronic or electrical components, which may be in wired or wireless communication with one another. For example, in one instance, the computer system may include at least one processor and/or associated transceiver in communication with at least one memory device and in communication with a user device associated with a user and with an agent interface associated with an agent. The at least one processor may be programmed to: (1) communicate with the user device to cause the user device to present the virtual environment, the virtual environment including at least one agent avatar associated with the agent; (2) receive, from the user device, user input data including one or more of live audio data, live video data, or live motion data; (3) generate a proposed response based upon the user input data; (4) determine whether an agent is present at the agent interface; (5) when the agent is present at the agent interface, cause the agent interface to display a recommendation including the proposed response; and/or (6) when the agent is not present at the agent interface, cause that at least one agent avatar to perform the proposed response within the virtual environment. The computer system may have additional, less, or alternate functionality, including that discussed elsewhere herein.

In another aspect, a computer-implemented method for generating a virtual reality replicant persona for interaction with at least one user may be provided. The computer-implemented method may be implemented via one or more local or remote processors, servers, transceivers, sensors, memory units, mobile devices, wearables, smart watches, smart contact lenses, smart glasses, augmented reality (AR) glasses, virtual reality (VR) headsets, mixed reality (MR) or extended reality glasses or headsets, voice bots or chatbots, ChatGPT or ChatGPT-based bots, and/or other electronic or electrical components, which may be in wired or wireless communication with one another. For example, in one instance, the computer-implemented method may be implemented by a computer system including at least one processor and/or associated transceiver in communication with at least one memory device and in communication with a user device associated with a user and with an agent interface associated with an agent. The method may include: (1) communicating with the user device to cause the user device to present the virtual environment, the virtual environment including at least one agent avatar associated with the agent; (2) receiving, from the user device, user input data including one or more of live audio data, live video data, or live motion data; (3) generating a proposed response based upon the user input data; (4) determining whether an agent is present at the agent interface; (5) when the agent is present at the agent interface, causing the agent interface to display a recommendation including the proposed response; and/or (6) when the agent is not present at the agent interface, causing that at least one agent avatar to perform the proposed response within the virtual environment. The method may include additional, less, or alternate actions, including those discussed elsewhere herein.

In yet another aspect, at least one non-transitory computer-readable media having computer-executable instructions embodied thereon may be provided. The computer-executable instructions may be executed by a computer system including at least one local or remote processor and/or associated transceivers in communication with at least one local or remote memory device and in communication with a user device associated with a user and with an agent interface associated with an agent. The computer-executable instructions may direct or cause the at least one processor to: (1) communicate with the user device to cause the user device to present the virtual environment, the virtual environment including at least one agent avatar associated with the agent; (2) receive, from the user device, user input data including one or more of live audio data, live video data, or live motion data; (3) generate a proposed response based upon the user input data; (4) determine whether an agent is present at the agent interface; (5) when the agent is present at the agent interface, cause the agent interface to display a recommendation including the proposed response; and/or (6) when the agent is not present at the agent interface, cause that at least one agent avatar to perform the proposed response within the virtual environment. The computer-executable instructions may direct additional, less, or alternate functionality, including that discussed elsewhere herein.

In yet another aspect, a computer system for interaction with a plurality of users in a virtual environment may be provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT or ChatGPT-based bots, and/or other electronic or electrical components, which may be in wired or wireless communication with one another. For example, in one instance, the computer system may include at least one memory device and at least one processor and/or associated transceiver in communication with the at least one memory device and one or more user devices. The at least one processor may be programmed to: (1) communicate with the one or more user devices to cause the one or more user devices to present the virtual environment, the virtual environment including at least one virtual lockbox associated with a first user of the plurality of users; (2) store one or more documents in the at least one memory device in association with the at least one virtual lockbox; (3) identify one or more authorized users of the plurality of users having been granted access to the at least one virtual lockbox; and/or (4) provide access to the one or more documents in response to the identified one or more authorized users interacting with the virtual lockbox in the virtual environment. The computer system may have additional, less, or alternate functionality, including that discussed elsewhere herein.

In yet another aspect, a computer-implemented method for interaction with a plurality of users in a virtual environment may be provided may be provided. The computer-implemented method may be implemented via one or more local or remote processors, servers, transceivers, sensors, memory units, mobile devices, wearables, smart watches, smart contact lenses, smart glasses, augmented reality (AR) glasses, virtual reality (VR) headsets, mixed reality (MR) or extended reality glasses or headsets, voice bots or chatbots, ChatGPT or ChatGPT-based bots, and/or other electronic or electrical components, which may be in wired or wireless communication with one another. For example, in one instance, the computer-implemented method may be implemented by a computer system including at least one memory device and at least one processor and/or associated transceiver in communication with the at least one memory device and one or more user devices. The method may include: (1) communicating with the one or more user devices to cause the one or more user devices to present the virtual environment, the virtual environment including at least one virtual lockbox associated with a first user of the plurality of users; (2) storing one or more documents in the at least one memory device in association with the at least one virtual lockbox; (3) identifying one or more authorized users of the plurality of users having been granted access to the at least one virtual lockbox; and/or (4) providing access to the one or more documents in response to the identified one or more authorized users interacting with the virtual lockbox in the virtual environment. The method may include additional, less, or alternate actions, including those discussed elsewhere herein.

In yet another aspect, at least one non-transitory computer-readable media having computer-executable instructions embodied thereon may be provided. The computer-executable instructions may be executed by a computer system including at least one memory device and at least one processor and/or associated transceiver in communication with the at least one memory device and one or more user devices. The computer-executable instructions may direct or cause the at least one processor to: (1) communicate with the one or more user devices to cause the one or more user devices to present the virtual environment, the virtual environment including at least one virtual lockbox associated with a first user of the plurality of users; (2) store one or more documents in the at least one memory device in association with the at least one virtual lockbox; (3) identify one or more authorized users of the plurality of users having been granted access to the at least one virtual lockbox; and/or (4) provide access to the one or more documents in response to the identified one or more authorized users interacting with the virtual lockbox in the virtual environment. The computer-executable instructions may direct additional, less, or alternate functionality, including that discussed elsewhere herein.

In yet another aspect, a computer system for interaction with a plurality of users in a virtual environment may be provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT or ChatGPT-based bots, and/or other electronic or electrical components, which may be in wired or wireless communication with one another. For example, in one instance, the computer system may include at least one memory device and at least one processor and/or associated transceiver in communication with the at least one memory device and one or more user devices. The at least one processor may be programmed to: (1) communicate with the one or more user devices to cause the one or more user devices to present the virtual environment; (2) receive sensor data from a first user device of the one or more user devices; (3) determine, based upon the received sensor data, that an accident has occurred; (4) in response to determining the accident has occurred, present, within the virtual environment to a first user using the first user device, one or more prompts for collecting information relating to the accident using the first user device; and/or (5) generate an accident profile including the information collected by the first user using the first user device in response to the one or more prompts. The computer system may have additional, less, or alternate functionality, including that discussed elsewhere herein.

In yet another aspect, a computer-implemented method for interaction with a plurality of users in a virtual environment may be provided may be provided. The computer-implemented method may be implemented via one or more local or remote processors, servers, transceivers, sensors, memory units, mobile devices, wearables, smart watches, smart contact lenses, smart glasses, augmented reality (AR) glasses, virtual reality (VR) headsets, mixed reality (MR) or extended reality glasses or headsets, voice bots or chatbots, ChatGPT or ChatGPT-based bots, and/or other electronic or electrical components, which may be in wired or wireless communication with one another. For example, in one instance, the computer-implemented method may be implemented by a computer system including at least one memory device and at least one processor and/or associated transceiver in communication with the at least one memory device and one or more user devices. The method may include: (1) communicating with the one or more user devices to cause the one or more user devices to present the virtual environment; (2) receiving sensor data from a first user device of the one or more user devices; (3) determining, based upon the received sensor data, that an accident has occurred; (4) in response to determining the accident has occurred, presenting, within the virtual environment to a first user using the first user device, one or more prompts for collecting information relating to the accident using the first user device; and/or (5) generating an accident profile including the information collected by the first user using the first user device in response to the one or more prompts. The method may include additional, less, or alternate actions, including those discussed elsewhere herein.

In yet another aspect, at least one non-transitory computer-readable media having computer-executable instructions embodied thereon may be provided. The computer-executable instructions may be executed by a computer system including at least one memory device and at least one processor and/or associated transceiver in communication with the at least one memory device and one or more user devices. The computer-executable instructions may direct or cause the at least one processor to: (1) communicate with the one or more user devices to cause the one or more user devices to present the virtual environment; (2) receive sensor data from a first user device of the one or more user devices; (3) determine, based upon the received sensor data, that an accident has occurred; (4) in response to determining the accident has occurred, present, within the virtual environment to a first user using the first user device, one or more prompts for collecting information relating to the accident using the first user device; and/or (5) generate an accident profile including the information collected by the first user using the first user device in response to the one or more prompts. The computer-executable instructions may direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed herein. However, it should be understood that the present embodiments are not limited to the precise arrangements and/or instrumentalities shown herein.

FIG. 1 illustrates a simplified block diagram of an exemplary computer system for interaction with at least one user in a virtual environment according to an exemplary embodiment of the present disclosure.

FIG. 2 illustrates an exemplary configuration of a client computer according to an exemplary embodiment of the present disclosure.

FIG. 3 illustrates an exemplary configuration of a server computing device according to an exemplary embodiment of the present disclosure.

FIG. 4A illustrates a flow chart of an exemplary computer-implemented process for interaction with at least one user in a virtual environment according to an exemplary embodiment of the present disclosure.

FIG. 4B is a continuation of the flow chart illustrated in FIG. 4A.

FIG. 5 illustrates a flow chart of an exemplary computer-implemented process for generating an avatar for an agent or other individual according to an exemplary embodiment of the present disclosure.

FIG. 6 depicts a flow chart of an exemplary computer-implemented process for providing a secure data exchange in a virtual environment such as the virtual environment described as an exemplary embodiment of the present disclosure.

FIG. 7 depicts a flow chart of an exemplary computer-implemented process for providing real time accident support in a virtual environment such as the virtual environment described as an exemplary embodiment of the present disclosure.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

For the purposes of this discussion, a replicant persona is an artificial intelligence driven digital recreation of an individual, such as, but not limited to, agents or representatives associated with a business and/or other individuals. These replicant personas can be associated with and/or represent real and fictional human or non-human individuals. The replicant persona may be trained to simulate a personality of an individual including replicating the traits of the individual including, but not limited to, their mannerisms, appearance, personality, historical and conversational talking points of an actual, real-life person.

For the purposes of this discussion, an avatar is an audio and/or visual representation of the individual being controlled by the replicant persona. In the exemplary embodiment, an avatar is used to interact with virtual reality users, such as in a virtual reality environment. In some embodiments, there may be multiple avatars for the same replicant persona. For example, multiple avatars for an individual may be in multiple locations in the virtual reality environment.

In the exemplary embodiment, an avatar may be connected to a replicant persona, where the replicant persona controls the actions and reactions of the individual avatars. For example, if a question is asked of the avatar, the question may be routed to the replicant persona, which formulates a response and transmits the response to the avatar. In some embodiments, a single replicant persona may control multiple avatars simultaneously. In some examples, an avatar may be performing as a virtual agent to sell an insurance policy and/or other products, receive and/or process insurance claims, and/or provide information and/or answer general insurance-related questions within the metaverse. In other words, an avatar associated with a replicant persona may be a virtual agent avatar and may sell insurance and/or other products to a user directly, or via a user avatar of a user described below.

For the purposes of this discussion, a user avatar is an audio and/or visual representation of a user that is directly controlled by that user within a virtual reality environment. The user avatar is controlled via the user computer device as the user is logged into the virtual reality environment. In some embodiments, the user avatar is a direct representation of the user. In other embodiments, the user avatar is anything that the user wishes to be within the virtual reality embodiment. The user may be able to modify their user avatar to change its appearance, such as by changing the appearance, clothing, hairstyle, and other attributes of the user avatar. In some embodiments, a user avatar is associated with an account of the user. In some of these embodiments, the user may have more than one account and therefore multiple user avatars. In some further embodiments, the user may have multiple user avatars associated with their account and use different ones at different times.

As used herein, “VR environment” or “virtual environment” refers to a digital or virtual environment experienced by or displayed to a user through a VR (virtual reality) computing device. In other words, “VR environment” refers to the VR view and functionality experienced by a user through a VR enabled computing device. Conversely, any virtual or digital environment displayed to a user through a VR computing device may be considered a VR environment.

As used herein, “AR environment” refers to a digital or virtual environment overlaid on a real-world environment and experienced by a user through a VR/AR (Augmented Reality) computing device. In other words, “AR environment” refers to the AR display and functionality experienced by a user through an AR enabled computing device. Mixed or extended reality (XR) devices may also be used for input and/or output.

In some further embodiment, the VR and/or AR may allow for haptic responses to allow the user to feel or sense an interaction with an object. The haptic response may be provided through the use of gloves or other feedback devices. In one embodiment, the haptic response allows the user to feel the texture of the 3-D object and/or the weight of the 3-D object. For example, the user may shake the avatar's hand or receive a virtual object from the avatar, and the user would be able to feel the handshake, or the object being handed to the avatar. In another embodiment, the haptic response may include vibrations, smell or other sensory outputs that may be sensed or experienced by an individual.

The present embodiments may relate to, inter alia, systems and methods for enhanced virtual reality interaction. In the exemplary embodiment, the systems and methods may generate a VR environment that includes one or more avatars and one or more virtual locations that may be visited by a user avatar controlled by a user with a user device (e.g., an AR or VR headset and/or other AR or VR system). These virtual locations may include places of business, such as insurance agencies, having real-world counterparts, and may be occupied by user avatars (e.g., if the agent is available live) and/or avatars associated with a replica persona of the agent (e.g., if the agent is not available live). By visiting the locations virtually, the user may purchase products or obtain information about the business, for example, by viewing overlays or aspects of the VR environment itself (e.g., virtual signage or documents included in the VR environment) and/or by interacting with an avatar associated with the corresponding agent (e.g., by asking questions and receiving responses from the agent or the agent's virtual replicant).

The avatar may generate responses to user requests, for example, using chatbot applications and/or artificial intelligence (AI) and/or machine learning (ML) models trained based upon historical interactions between users and agents. These generated responses may include, for example, speech, gestures, and/or other expressions to be made by the avatar and/or, if a live agent is present, prompts to the live agent to make such speech, gestures, and/or other expressions. As interactions are performed within the VR environment and additional interaction data becomes available, this additional interaction data may be used to update and refine the program and/or model responsible for generating responses so that the responses may be more effective in obtaining or providing information and/or positively impacting an emotional state of the user.

By visiting and interviewing agents in a virtual setting, the user does not need to physically travel to interact with different agents, therefore making it easier for users in remote locations to interact with one or more agents, and also making it easier for users identify an agent having attributes (e.g., background, affinity, demographics, technical skills, language skills, experience, education, hobbies, etc.) compatible with or considered desirable by the user. For example, by visiting one or more virtual locations, users can get to know different agents by interviewing and/or viewing information (e.g., introductory videos) relating to the agent.

Additionally, data provided by the user or agent may be recorded and stored in a database, so that the data may be retrieved seamlessly for future interactions within the VR environment and for traditional interactions outside of the VR environment. For example, records of interactions within the virtual environment may be used to process any transactions and/or agreements that may have occurred within the virtual environment.

The system may further provide for a secure exchange of documents and/or other data using a virtual lockbox mechanism. The virtual lockbox may enable a user to securely store documents and to authorize other users to access the documents. For example, a user may, through input (e.g., within the virtual environment, a mobile app, and/or web page) designate documents (e.g., insurance policy documents, insurance cards, and/or documents and/or other data relating to insurance claims) to be stored in the virtual lockbox, or the documents may automatically be stored in association with the virtual lockbox in response to certain events (e.g., purchase or renewal of an insurance policy and/or filing of an insurance claim). The user may also designate other users (e.g., agents, other individuals involved in an insurance claim) to access any of these stored documents, or the system may determine which individuals to be authorized for access. These authorized users may then retrieve, view, and/or trigger a download of these documents, for example, by accessing the virtual lockbox within the virtual environment. In embodiments in which the virtual lockbox includes insurance-related documents, this access to the virtual lockbox enables the authorized users to access those documents and quickly determine coverage in real time in case of an accident or other insurance-related event. It should be noted that access to the virtual lockbox may further include access to certain documents included within the lockbox and no access to other documents within the lockbox. In other words, a blanket or broad access may be given to a certain user by the authorized user so that that the broad access user is able to see and access all documents included within the virtual lockbox. In another case, a user may be given limited or targeted access to a specific set of documents included in the virtual lockbox, and that limited access user would only be able to see and access those documents.

The system may further provide for a real time accident support in the virtual environment. The system may receive sensor data from the user devices (e.g., data captured by smart glasses), which may be used to determine if an accident (e.g., a vehicular collision or other incident resulting in injury and/or property damage) has occurred. In response to detecting an accident and/or receiving input from the user (e.g., as a voice command) that an accident has occurred, the system may prompt the user to interact with a live agent and/or replicant persona in the virtual environment as described above.

The system may provide guidance and/or instructions to the user via the user device, for example, as prompts displayed within the virtual environment and/or instructions provided by an agent avatar. These prompts may include text or speech (e.g., speech associated with the virtual avatars described above). The prompts may include questions verifying that the user is not injured or to provide information about what has occurred. For example, the prompts may instruct the user to take pictures and/or ask questions to others present at the scene of the accident. The user device may also passively collect data, such as image and/or audio data, in response to the accident being detected.

This collected information may be used to determine if additional resources, such as emergency personnel or insurance personnel, need to be contacted, and automatically initiate such contact (e.g., by initiating an emergency “9-1-1” call and/or presenting an agent avatar within the virtual environment as described above). The collected information may further be used to generate digital twins, simulations, and/or visual reconstructions of the accident, which may be used to determine an extent of damage or injury that has occurred and the cause of the accident, such as vehicle or vehicle system or component failure (such as in the case of autonomous vehicles or smart vehicle automated systems) and/or identify those innocent and not to blame for the accident. In some embodiments, these reconstructions may be viewed within the virtual environment.

### Providing User Interactions in a Virtual Environment

In the exemplary embodiment, the system may communicate with the user device to cause the user device to present the VR environment. The system may provide video data, audio data, or other data (e.g., haptic feedback data) that may be presented to the user by the user device. The system may receive user input data such as live audio data, live video data, or live motion data from the user device, and based upon this received user input data, the system may continually update the VR environment. For example, the system may respond to motion, voice commands or other speech, and/or other input (e.g., facial expressions) of the user. In some embodiments, if the system determines that the user is visiting a location within the VR environment based upon the input data, an agent or other individual associated with the location may receive a notification.

In the exemplary embodiment, the system may generate a proposed response to a user based upon received user input data. User input that indicates a response may be required may include questions input by the user (e.g., as voice or text) or other actions by the user. For example, if the user is not talking but has a confused facial expression, the system may determine that information or some other assistance should be offered to the user. The proposed response may include information to provide the user (e.g., specific language to speak to the user and/or documents to provide to the user), motions or gestures to be performed by the agent avatar, or other actions.

The proposed response may be generated using an AI model or a machine-learning model, such as by using one or more chatbots and/or using AI programs such as ChatGPT. Such models may be trained using historical interaction data and/or conversation data, such as historical real or simulated interactions between users (e.g., between an agent and another user) and corresponding outcomes. For example, records of historical responses may be associated with certain reactions for a user, such as the user providing a certain type of information or the user displaying (e.g., verbally and/or through tone and/or body language) a certain emotional response. The model may use these historical associations to predict how a user may react to a future generated response and select an appropriate response to generate based upon this prediction. Additionally, as described in further detail below, the model may be trained so that the responses emulate a personality or mannerisms of user. The response may therefore by generated based upon outputs of the model in combination with other computer-defined rules or requirements.

As additional interaction data, such as generated responses and their corresponding reactions, is generated, the model may be updated and/or retrained based upon this new interaction data. This enables the model to refine its ability to generate proposed responses that effectively obtain information (e.g., by providing a user with questions that are move likely to prompt the user to provide needed information) or provide information (e.g., by better identifying and conveying information desired by a user and/or presenting information in a way that is easy to understand or has a positive effect on a user's emotional state).

In some embodiments, these responses may include actions outside of the VR environment, such as sending emails, phone messages, and/or text messages to the user. For example, if the user agrees to a purchase within the VR environment, the system may transmit documents for the user to sign or forms for the user to submit payment information as an email and/or web link. In some embodiments, transmission of these documents may be triggered by analogous actions in the VR environment, such as by dropping a document into a virtual mailbox. In some embodiments, these responses may include real-time binding offers or quotes (e.g., insurance quotes), to which the user may accept within the VR environment. These may be generated based upon data provided by the user within the VR environment and/or other retrieved data about the user (e.g., from a user profile and/or other web sources or databases accessible by the system). Any input from the user or agent may be recorded by the system to enable such transactions to be processed and referred back to in the future.

In certain embodiments, when the system generates a proposed response, the system may determine whether an agent is present at an agent interface (e.g., a computer and/or an VR or AR headset through which the agent may control a respective avatar). For example, the system may determine whether the agent is logged in and/or has made any input through the user interface (e.g., speech, motion, keystrokes, etc.) within a threshold period of time. When the agent is present at the agent interface, the system may cause the agent interface to display a recommendation including the proposed response. For example, the recommendation may be displayed as an overlay within the VR environment visible to the agent, although not visible to the user or others accessing the VR environment.

In these cases, the recommendations may direct the agent on how to respond to questions, statements, gestures, facial expressions, and/or other actions made by the user. For example, if the system determines the user is becoming confused during an interaction with the agent, the generated recommendations may direct the agent to slow down and/or offer additional explanation. These recommendations may be generated using one or more chatbots and/or using AI programs such as ChatGPT. In some embodiments, if the user and agent speak different languages, the system may provide translation in real time.

In the exemplary embodiment, when the agent is not present at the agent interface, the system cause that at least one avatar associated to perform the proposed response based upon a replicant persona associated with the agent. In such cases, the avatar may replicate the traits of the agent including, but not limited to, the mannerisms, appearance, personality, historical and conversational talking points. Actions or responses of the replicant persona may be generated using one or more chatbots and/or using AI programs such as ChatGPT. Accordingly, the avatar may act as a user interface for the business when the agent is not present or unavailable, with the avatar interacting with users to provide information about and to collect information for the business.

For instance, a replicant persona for an agent or other representative for a business may be created and stored. When a user in a virtual reality environment walks into the virtual reality representation of the business, the user is greeted by an avatar of the agent that can answer questions and potentially handle the user's request(s). In some embodiments, a new avatar (e.g., each representing the agent) may be generated to interact with each user. These could be multiple avatars each connected to different personas or multiple avatars with the same persona. Therefore, multiple users could be interacting with their own version of the avatar of the agent, simultaneously. This allows the business to provide a personal, singular engagement.

In a further example, an avatar generated to interact with a user may be trained to interact with the user within the metaverse in accordance with certain traits of the agent learned through virtual or actual interaction with the user. In one example, the traits of the agent may include the agent's body language, the agent's speaking accent and/or dialect observed from an initial interaction (real or virtual) with the agent for a specific training period (e.g., initial 5 minutes or 10 minutes). Additionally, or alternatively, the traits of the agent may be retrieved from a database in which the agent's profile and the traits of the agent are stored.

In some embodiments, the avatar may be interacting with the user to sell a new product or service (e.g., insurance products) for the user's newly purchased home or vehicle, or the avatar may be interacting with the user for a claim submitted by the user for an accident or a loss of a vehicle, or damage to the user's home, and so on. Accordingly, the avatar may be trained to show empathy, excitement, joy, kindness or some other emotion that is appropriate with the cause of the interaction with the user. Additionally, or alternatively, certain traits or mannerisms of the avatar representing the agent, which may help to increase the user's confidence and trust in the product and/or service being marketed or sold by the avatar, may be used to train the avatar to incorporate those traits and/or mannerisms into the avatar during interaction with the user. In some cases, those traits or mannerisms incorporated into the agent's avatar may include similar traits and mannerism expressed by the user or the user's avatar.

In some embodiments, the avatar may initially be controlled by a live agent, for example, to respond to or greet the user, and/or to interact with the user to provide answers or information to the user. However, based upon the monitoring of the virtual interaction between the avatar being controlled by the real agent and the user, if it is determined that the interaction is not meeting a specific criterion, for example, the real agent's interactions with the user are not generating the desired responses or feedback from the user, the avatar may be controlled by an AI model or a machine-learning model to meet the specific criterion. For example, the real agent may be having a bad day, and, therefore, may be unable to show an appropriate level of empathy to the user while interacting with the user. Upon detecting such a condition or feedback from the user, the system may control the avatar via the AI model or the ML model to adjust the level of empathy being presented to the user. Conversely, if is determined that a computer-controlled avatar is a specific criterion, the system may alert a live agent to take control of the avatar.

In some examples, based upon an agent profile of the agent or historical interactions with the agent, if it is determined that the agent has a specific accent or dialect associated with a specific geographic location, the avatar may interact with the user using the specific accent or dialect. If it is learned that the agent frequently uses jokes, or one-liners while interacting, the avatar may be trained to use similar behavior while interacting with the user, which is likely to increase a comfort level of the user while interacting with the agent's avatar.

In addition, using a microphone and/or a camera, the agent's facial gestures, hand gestures, body language, and so on, may be recorded (e.g., while the agent is controlling the avatar live) and used for training the avatar to interact with the user in a specific way. An AI model or a machine-learning (ML) model may be used to train the avatar to identify which traits of the agent are beneficial to mimic or reproduce to increase the user's trust and confidence, and/or which traits of the agent may not be used by the avatar. The AI or ML model may also be used to train the avatar to use empathy corresponding to the cause of interaction with the avatar. For example, if the user has bought a new home or vehicle and is interacting with the avatar to purchase a new insurance policy, the avatar may use a happy or celebration tone while interacting with the user. Similarly, if the user is interacting with the avatar to report a damage or injury claim, the avatar may use a more supportive tone while interacting with the user.

The replicant persona, based upon which the avatar may be controlled, may be generated using one or more of Deep/Machine Learning (ML), Natural Language Processing (NLP), Voice Intelligence, and Artificial Intelligence (AI) to digitally replicate physical features and personality traits, mannerisms, voices, conversational style, quirks, interactions, facial expressions, hand gestures and/or other visible or audible mannerisms, and historical data and roles of the agent. The replicant persona is then used to generate one or more avatars to create unique and personalized experiences for users in a virtual reality or augmented reality space.

Data used to develop this replicant persona may include, but is not limited to, all available interactions from movies, videos, social media posts, interviews, recordings, images, scripts, other sources where a person's (e.g., an agent's) true personality and style could ultimately be captured, and/or current or previous interactions with the user. These data points could then be synthesized by deep/machine learning and cognitive computing and AI Voice subfields to accurately represent the agent and how they might respond given certain inputs and scenarios while interacting with the user.

The replicant persona can be used to generate individual avatars for different interactions. In some further embodiments, the individual avatar may be loaded with or have access to information about the individual user that the avatar is interacting with. For example, the avatar may know the user's name and call them by name directly. In a business interaction, the avatar may know additional information about the user, up to and including account details and/or other private or personally identifiable information.

In some embodiments, where the person (e.g., agent) to be represented by the avatar is available, the system may use a 3-D indexing tool to scan the agent. The 3-D indexing tool may scan and capture the physical essence of the agent including, but not limited to physical attributes, tattoos, hair style, make-up, clothing, and other interesting aspects of the agent to use with an avatar that interacts with the user.

In some examples, a user may use his/her user avatar to interact with the virtual reality environment, including interacting with other user avatars in the environment. While a user avatar represents the individual user on a one-to-one basis, a replicant persona can have multiple avatars executing simultaneously in different areas of the virtual reality. For example, a first user may be in a virtual room with a first avatar of the replicant persona, while a second user is in a separate virtual room with a second avatar of the same replicant persona. The first user and the second user are able to separately and simultaneously interact with their own avatar of the replicant person.

The use of Virtual Reality (VR) and Augmented Reality (AR) for interacting with 3D avatars provides a new interface for interacting in new ways. VR and AR systems allow a user to interact with a 3D virtual environment in a new way compared to traditional interactions using a two-dimensional (2-D) display. In VR, a user may be immersed in a virtual environment (e.g., using a VR headset). In other words, a VR device displays images, sounds, etc. to the user in a way that mimics how a user receives sensory stimuli in the real world. In AR, the user may be provided with digital data that overlays objects or environments in the real world (such as via AR glasses). AR devices may use a camera or other input to determine the objects in a user's line of sight and present additional digital data that compliments the real-world environment.

Examples of VR environments may include, but are not limited to, Minecraft® (Minecraft is a registered trademark of Microsoft Corporation, Redmond, Washington), Metaverse, and Second Life® (Second Life is a registered trademark of Linden Lab of San Francisco, CA). These VR environments allow the user to interact with and modify said environments using VR tools, such as by building and creating content including structures and objects.

As described in further detail herein, VR and AR technologies may be utilized to more effectively interact with avatars, such as described herein. In one embodiment, a user interacts with an avatar using VR. Specifically, the user navigates a virtual environment, applying bounding frames to objects, labeling objects, rotating views, and traversing areas of the virtual environment using a VR device. The user also interacts with individual avatars in the virtual environment. These avatars can be other users with their user avatars or avatars controlled by replicant personas as described herein. In other words, the user is immersed in a virtual environment and interacts with the virtual environment through the VR device in order to interact with and/or view 3D objects and avatars. In one embodiment, the virtual environment is a recreation and/or representation of a place of business and the user interacts with avatars in the place of business to conduct transactions with the business.

In another embodiment, a user views a real-world environment, and an AR device displays virtual content overlaying the real-world environment. Specifically, if the user is in a geographic location associated with the geographic location of an avatar, the AR device may overlay the real-world environment with the avatar from the 3D digital environment, allowing the user to interact with the digital environment and digital objects. For example, the user may be in a place of business, and the user may receive information about the business or its products as an overlay.

### Providing Secure Data Exchange in a Virtual Environment

In the exemplary embodiment, the system may provide for a secure exchange of documents and/or other data using a virtual lockbox mechanism. The virtual lockbox may enable a user to securely store documents and to authorize other users to access the documents. For example, a user may, through input (e.g., within the virtual environment, a mobile app, and/or web page) designate documents (e.g., insurance policy documents, insurance cards, and/or documents and/or other data relating to insurance claims) to be stored in the virtual lockbox, or the documents may automatically be stored in association with the virtual lockbox in response to certain events (e.g., purchase or renewal of an insurance policy and/or filing of an insurance claim). The user may also designate other users (e.g., agents, other individuals involved in an insurance claim) to access any of these stored documents, or the system may determine which individuals to authorize access to certain documents stored within the virtual lockbox. These authorized users may then retrieve, view, and/or trigger a download of these documents, for example, by accessing the virtual lockbox within the virtual environment. In embodiments in which the virtual lockbox includes insurance-related documents, such access enables authorized users to quickly access these documents and determine insurance coverage in real time in case of an accident or other insurance-related event.

The lockbox may be implemented using a database structure. For example, each lockbox may be defined by a lockbox identifier in the database and be stored in association with other information such as an associated user and/or user identifier, user preferences, documents, and information about permissions to access documents, as described in further detail below. The lockbox identifier may be further associated with the virtual representation of the lockbox within the virtual environment. Thus, the information associated with the lockbox identifier may be accessed or modified based upon detected interactions within the virtual environment as described in further detail below.

In the exemplary embodiment, the system may be configured to communicate with one or more user devices to cause those user devices to present the virtual environment to include at least one virtual lockbox associated with a first user. In some embodiments, the virtual lockbox may appear similar to an actual lockbox or any other item (e.g., a safe or a file cabinet) users would likely understand to indicate a secure place to store documents. Alternatively, the virtual lockbox may appear as any other type of item, point, or node within the virtual environment labeled as such (e.g., an icon or button). As described above, each user may have a corresponding user avatar, which may interact with the virtual lockbox within the virtual environment analogously to how a person may interact with a lockbox in real life (e.g., opening or closing and/or depositing or withdrawing documents). As described in further detail below, access to and/or the appearance of the lockbox to a particular user may be controlled based upon whether the particular user is authorized to access any documents stored in the virtual lockbox. Within the virtual environment, the virtual lockbox may include and/or be labeled with text or indicators providing information about the virtual lockbox (e.g., which user is associated with the lockbox, a relationship between the viewer and the user is associated with the lockbox, and/or whether the viewer has access to any documents in the virtual lockbox). For example, the lockbox may include a lock that requires a combination or code to be entered to allow a user to access documents included within the lockbox. A different code may be tied to the different documents included with in the virtual lockbox such that when a code is entered only the documents linked to that code are shown and are accessible by that user.

In the exemplary embodiment, the system may be configured to store one or more documents in the memory in association with the virtual lockbox. For example, the user may designate documents to store in association with the virtual lockbox or the system may automatically determine and store, or suggest to store, documents in association with the virtual lockbox. In some embodiments, the user may input instructions at a mobile device via a mobile application instructing the system to store documents in association with the at least one virtual lockbox. The system may then store the one or more documents in association with the at least one virtual lockbox in response to receiving the instruction. In some embodiments, the user may generate user input data (e.g., by making corresponding movements and gestures) with the user device that indicates an intention to store the one or more documents in association with the virtual lockbox (e.g., dragging and placing, or selecting from a menu). The system may then store the one or more documents in association with the virtual lockbox in response to receiving this user input data. In some embodiments, the system may automatically identify documents to store. For example, the system may identify any insurance policy document, insurance cards, and/or insurance claim documents that are associated with the user, and may automatically store the documents or generate recommendations for the user to store the documents in the virtual lockbox.

In the exemplary embodiment, the system may be configured to identify one or more authorized users of the plurality of users to enable access to the at least one virtual lockbox. In some embodiments, the user associated with the lockbox may select other users to receive authorization. For example, the user may submit instructions at the mobile device via the mobile application instructions to designate one or more users as authorized to access the one or more documents, and the system may identify one or more authorized users based upon the received instruction. The user may submit similar instructions through another channel, such as through interaction within the virtual environment itself and/or through another computing device. In some embodiments, the system may automatically determine who should have access to the virtual lock box. For example, the system may identify any agents associated with the user and/or any other individuals involved in claims submitted by the user (e.g., other parties of an accident, other insurers, police officers, repair technicians, etc.) as authorized to access one or more of the documents stored in association with the virtual lockbox.

In the exemplary embodiment, the system may be configured to provide access to the one or more documents in response to the identified one or more authorized users interacting with the virtual lockbox in the virtual environment. For example, the authorized users may open, click or tap on, or otherwise interact with the virtual lockbox in the virtual environment, which may enable the authorized users to view of download the documents. In some embodiments, the documents may be viewed within the virtual environment. Additionally or alternatively, accessing the documents in the virtual environment may trigger a download or other transfer of data that enables the documents to be viewed through a different channel, such as through the mobile app, web page, and/or another type of file-viewing application.

For example, one or more predefined gestures and/or other actions (e.g., verbal statements) may be stored. When one of these gestures or other actions, for example, motion consistent with opening a virtual representation of the virtual lockbox within the virtual environment, are detected when a user is within appropriate proximity to the virtual lockbox within the virtual environment, the system may determine if the user has permission to retrieve any of the documents stored in the database in association with the corresponding lockbox identifier based upon the permissions information associated with the corresponding lockbox identifier. If so, the user may initiate retrieval and viewing of any of these documents from the database by making further corresponding gestures and/or other actions.

### Providing Real Time Accident Support in a Virtual Environment

In the exemplary embodiment, the system may provide for a real time accident support in the virtual environment. The system may receive sensor data from the user devices (e.g., data captured by smart glasses), which may be used to determine if an accident (e.g., a vehicular collision or other incident resulting in injury and/or property damage) has occurred. In response to detecting an accident and/or receiving input from the user (e.g., as a voice command) that an accident has occurred, the system may prompt the user to interact with a live agent and/or replicant persona in the virtual environment as described above.

The system may provide guidance and/or instructions to the user via the user device, for example, as prompts displayed within the virtual environment and/or instructions provided by an agent avatar. These prompts may include text or speech (e.g., speech associated with the virtual avatars described above). The prompts may include questions verifying that the user is not injured or to provide information about what has occurred. For example, the prompts may instruct the user to take pictures and/or ask questions to others present at the scene of the accident.

The user device may also passively collect data, such as image and/or audio data, in response to the accident being detected. This collected information may be used to determine if additional resources, such as emergency personnel or insurance personnel, need to be contacted, and automatically initiate such contact (e.g., by initiating an emergency “9-1-1” call and/or presenting an agent avatar within the virtual environment as described above). The collected information may further be used to generate digital twins, simulations, and/or visual reconstructions of the accident, which may be used to determine an extent of damage or injury that has occurred and the cause of the accident, such vehicle component or system malfunction to properly assign fault. In some embodiments, these reconstructions may be viewed within the virtual environment.

In the exemplary embodiment, the system may be configured to receive sensor data from the user devices. For example, at least some of the user device may include cameras, microphones, motion sensors (e.g., accelerometers and/or gyroscopes), location sensors (e.g., GPS), radar, lidar, and/or any other types of sensors. This data may be received (e.g., continuously or periodically) prior to, during, and following an accident. As described in further detail below, this senor data may be used by the system to determine when an accident has occurred and to gather information about the nature, scene, context, and results of the accident.

In the exemplary embodiment, the system may be further configured to determine, based upon the received sensor data, that an accident has occurred. In some embodiments, this determination may be made by analyzing audio, video, and/or motion data, for example, using AI and/or ML techniques and/or by comparing such data to one or more predefined thresholds indicative that an accident has occurred (e.g., a vehicle decelerating more quickly that would be possible using the brakes).

Such models may be trained using historical sensor data and corresponding outcomes. For example, historical patterns of sensor data may be associated with accident events. The model may use these historical associations to identify patterns of sensor data that are likely associated with an accident and predict that an accident has occurred based upon received sensor data. For example, the model may generate thresholds (e.g., values associated with vehicle movement) or profiles (e.g., speech patterns) that are associated with an occurrence of an accident and compare received sensor data to these thresholds and/or profiles. In certain embodiments, this model may be updated and/or retrained over time as additional sensor data becomes available.

In some embodiments, the determination may be made based upon detected voice, speech, facial expressions, and/or gestures made by the user or other individuals in the area. For example, in some embodiments, the system may utilize specific voice commands or phrases made by the user (e.g., saying “in an accident”) to determine an accident has occurred and initiate an appropriate response. Additionally, or alternatively, the system may analyze non-structured speech or voice (e.g., using AI and/or chatbots) to determine that the non-structured speech or voice indicates an accident has occurred. When it is determined an accident has occurred, the user may be alerted to launch or access the virtual environment via the user device using voice commands.

In some embodiments, the system may configured to detect one or more voice commands input by the first user to the first user device. As described above, some of these voice commands may relate to an indication that an accident has occurred. Additionally, the voice commands may request specific actions, such as contacting an agent (e.g., by saying “contact my agent”) or calling emergency services (e.g., by saying “call 9-1-1”).

The system may analyze these voice commands (e.g., using AI and/or chatbots and/or by performing a lookup based upon the received speech) to determine an appropriate response. For example, saying “contact my agent” may brings the agent, agent staff, agent machine learning bot/avatar or replicant persona, or claim representative into the metaverse channel for discussion or other interaction with the user. For example, the system may present within the virtual environment to an agent using an agent device of the user devices, a prompt to communicate with the user within the virtual environment. As described above, the system may generate responses to be performed by avatars and/or recommended to live agents and/or other agent personnel, and may retrieve relevant policy documents for review by the agent. In some embodiments, the system may determine to perform these actions (e.g., contacting emergency personnel) even without a specific voice command. For example, if the system determines a sufficiently severe accident has occurred, the system may automatically contact emergency personnel through an appropriate channel to request assistance and/or provide relevant information (e.g., a location of the accident and/or identities of persons involved).

In the exemplary embodiment, in response to determining the accident has occurred, the system may be configured to present within the virtual environment one or more prompts for collecting information relating to the accident using the user device. The prompts may be presented as text, audible commands, and/or statements made by avatars within the virtual environment. Examples of such prompts may include instructions to take pictures of the accident scene and where and/or questions to ask others at the scene of the accident. In some embodiments, these prompts may be generated using AI and/or chatbot technology, for example, to gather as much information as possible relevant to completing an insurance claim. The system may record interactions or other information resulting from the user following these instructions. This information, such as the captured pictures and/or statements made by others at the scene of the accident (e.g., witness accounts of what happened, statements indicating what happened, contact information, etc.), may be transmitted by the user device back to the system to be recorded and/or analyzed further.

In some embodiments, the system may automatically identify other individuals at the scene of the accident. For example, the system may detect one or more devices proximate to the user device (e.g., using Bluetooth device identification and/or another appropriate form of wireless communication), and may perform a lookup to identify individuals present at a scene of the accident based upon the detected one or more devices. In some embodiments, the system may identify individuals based upon detecting and analyzing voices of or statements made by the individuals detected by the user device.

In the exemplary embodiment, the system may be further configured to generate an accident profile including the information collected by the user using the first user device in response to the one or more prompts. The accident profile may be a database, database component, and/or data structure that stores various types of information associated with the accident. In addition to the sensor data and information gathered by the user associated with the accident, other relevant data may be recorded in association with the accident profile, such as a date, time, location, weather, traffic, maps, geographic models or vehicle models, and/or other data associated with or providing context to the accident. In some embodiments, the system may retrieve additional documents, such as a police report, insurance policy documents, insurance claim documents, and/or estimates or receipts from mechanics associated with the accident and store these documents in association with the accident profile.

In some embodiments, the system may generate one or more digital twins representing people, vehicles, or other objects involved in the accident and/or a visual representation and/or reconstruction of the accident based upon information included in the accident profile. For example, the system may parse the accident profile for sensor data, speech data, and/or documents relating to the accident to identify positions and orientations of relevant people and objects during the course of the accident. In some embodiments, AI and/or ML techniques may be utilized for such parsing. In some embodiments, the system the visual representation may be presented within the virtual environment, so that agents or others reviewing the accident may do so in a three-dimensional environment.

At least one of the technical problems addressed by this system may include: (i) improving interactions in virtual reality by detecting and mimicking certain mannerisms and personality traits of a user including the emotions of the user and the subject matter of the conversation during the interaction with the user; (ii) improving accuracy of artificial intelligence driven avatars in virtual reality; (iii) improving the human response to interactions with AI driven avatars; (iv) providing access to interact remotely with agents in an environment simulating a face-to-face interaction; (v) facilitating an exchange of information through a virtual environment by enabling recording interactions within the environment and triggering exchange of information through different channels in response to interactions within the virtual environment; (vi) improving interactions within a virtual environment by providing recommendations for responding to user input including voice, gestures, and facial expressions; (vii) providing an ability to securely transfer documents and/or other data in a metaverse environment; (viii) providing an ability for a plurality of individuals to access a set of documents in real time.

The computer-based or computer-implemented methods and computer systems described herein may be implemented (i) using computer programming or engineering techniques including computer software, firmware, hardware, or any combination or subset thereof, and/or (ii) by using one or more local or remote processors, transceivers, servers, sensors, servers, scanners, AR or VR headsets or glasses, smart glasses, wearables, smart watches, mobile devices, laptops, video game systems, and/or other electrical or electronic components, wherein the technical effects may be achieved by performing at least one of the following action or operations: (1) communicate with the user device to cause the user device to present the virtual environment, the virtual environment including at least one agent avatar associated with the agent; (2) receive, from the user device, user input data including one or more of live audio data, live video data, or live motion data; (3) generate a proposed response based upon the user input data; (4) determine whether an agent is present at the agent interface; (5) when the agent is present at the agent interface, cause the agent interface to display a recommendation including the proposed response; (6) when the agent is not present at the agent interface, cause that at least one agent avatar to perform the proposed response within the virtual environment.

### Exemplary Computer Network

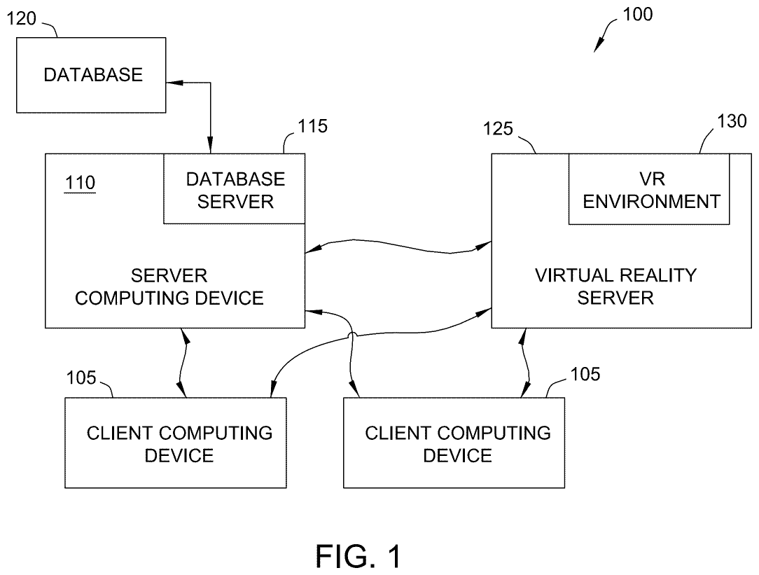

FIG. 1 depicts a simplified block diagram of an exemplary computer system 100. In the exemplary embodiment, system 100 may be used for providing a VR environment to enable a user to interact with a live or virtual agent.

In the exemplary embodiment, client computer devices 105 are computers that include a web browser or a software application, which enables client computer devices 105 to access server computing device 110 using the Internet. More specifically, client computer devices 105 are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Client computer devices 105 may include the user device and/or agent interface described herein.

Client computer devices 105 may be any device capable of accessing the Internet including, but not limited to, a mobile device, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), or XR (extended reality) headsets or glasses), smart glasses, a kiosk, chat bots, or other web-based connectable equipment or mobile devices. In some embodiments, client computer devices 105 are capable of accessing VR environments 130, such as through virtual reality servers 125.

A database server 115 may be communicatively coupled to a database 120 that stores data. In one embodiment, database 120 may include scan files, replicant personas, digital twins, VR environments 130, business information, user information, and/or user preferences. In the exemplary embodiment, database 120 may be stored remotely from server computing device 110 and/or virtual reality server 125. In some embodiments, database 120 may be decentralized. In the exemplary embodiment, a person may access database 120 via client computer devices 105 by logging onto server computing device 110 and/or virtual reality server 125, as described herein.

Server computing device 110 may be communicatively coupled with one or more the client computer devices 105. In some embodiments, server computing device 110 may be associated with, or is part of a computer network associated with business, or in communication with the business' computer network (not shown). In other embodiments, server computing device 110 may be associated with a third party and is merely in communication with the business' computer network. In some of these embodiments, server computing device 110 is associated with a virtual reality server 125.

One or more virtual reality servers 125 may be communicatively coupled with server computing device 110. The one or more virtual reality servers 125 each may be associated with a VR environment 130. Virtual reality servers 125 may provide tools and/or applications for users to access their associated VR environments 130 over the Internet. For the purposes of this discussion, VR environments 130 provide immersive environments that simulates how a user receives stimuli in the real world.

In one example, virtual reality (VR) goggles allow a user to see a virtual world. The VR goggles determines when the user turns their head and then renders imaging of what is where the user is looking. Furthermore, the user may use input tools, such as controllers to interact with the environment displayed by the goggles. A user may then interact with digital objects or avatars that have been added to the VR environment 130.

In some embodiments, VR environments 130 simulate parts or portions of the real-world and allow users to own and alter locations in the VR environments 130. For example, a user may own a plot of virtual land and build a version of their real-world house on that plot of land. Or a business could build an office or shop to allow users to interact with the replicant persona avatars in that office or shop.

In the exemplary embodiment, server computing device 110 and/or virtual reality server 125 may communicate with a user device (e.g., client computer device 105) to cause the user device to present VR environment 130. Server computing device 110 and/or virtual reality server 125 may provide video data, audio data, or other data (e.g., haptic feedback data) that may be presented to the user by the user device. Server computing device 110 and/or virtual reality server 125 may receive user input data such as live audio data, live video data, or live motion data from the user device, and based upon this received user input data, server computing device 110 and/or virtual reality server 125 may continually update the VR environment 130. For example, the system may respond to motion, voice commands or other speech, and/or other input (e.g., facial expressions) of the user. In some embodiments, if server computing device 110 and/or virtual reality server 125 determines that the user is visiting a location within the VR environment 130 based upon the input data, an agent or other individual associated with the location may receive a notification.

In the exemplary embodiment, server computing device 110 may generate a proposed response to a user based upon received user input data. User input that indicates a response may be required may include questions input by the user (e.g., as voice or text) or other actions by the user. For example, if the user is not talking but has a confused facial expression, server computing device 110 may determine that information or some other assistance should be offered to the user. The proposed response may include information to provide the user (e.g., specific language to speak to the user and/or documents to provide to the user), motions or gestures to be performed by the agent avatar, or other actions.

The proposed response may be generated by server computing device 110 using an AI model or a machine-learning model, such as by using one or more chatbots and/or using AI programs such as ChatGPT. Such models may be trained using historical interaction data and/or conversation data, such as historical real or simulated interactions between users (e.g., between an agent and another user) and corresponding outcomes. For example, records of historical responses may be associated with certain reactions for a user, such as the user providing a certain type of information or the user displaying (e.g., verbally and/or through tone and/or body language) a certain emotional response. The model may use these historical associations to predict how a user may react to a future generated response and select an appropriate response to generate based upon this prediction. Additionally, as described in further detail below, the model may be trained so that the responses emulate a personality or mannerisms of user. The response may therefore by generated based upon outputs of the model in combination with other computer-defined rules or requirements.

As additional interaction data, such as generated responses and their corresponding reactions, is generated, the model may be updated and/or retrained by server computing device 110 based upon this new interaction data. This enables the model to refine its ability to generate proposed responses that effectively obtain information (e.g., by providing a user with questions that are move likely to prompt the user to provide needed information) or provide information (e.g., by better identifying and conveying information desired by a user and/or presenting information in a way that is easy to understand or has a positive effect on a user's emotional state).

In some embodiments, these responses may include actions outside of the VR environment 130, such as sending emails, phone messages, and/or text messages to the user. For example, if the user agrees to a purchase within the VR environment 130, server computing device 110 may transmit documents for the user to sign or forms for the user to submit payment information as an email and/or web link. In some embodiments, transmission of these documents may be triggered by analogous actions in the VR environment 130, such as by dropping a document into a virtual mailbox. In some embodiments, these responses may include real-time binding offers or quotes (e.g., insurance quotes), to which the user may accept within the VR environment 130. These may be generated based upon data provided by the user within the VR environment 130 and/or other retrieved data about the user (e.g., from a user profile and/or other web sources or databases such as database 120 accessible by server computing device 110). Any input from the user or agent may be recorded by server computing device 110 to enable such transactions to be processed and referred back to in the future.

In the exemplary embodiment, when server computing device 110 generates a proposed response, server computing device 110 may determine whether an agent is present at an agent interface (e.g., client computer device 105). For example, server computing device 110 may determine whether the agent is logged in and/or has made any input through the user interface (e.g., speech, motion, keystrokes, etc.) within a threshold period of time.

When the agent is present at the agent interface, server computing device 110 may cause the agent interface to display a recommendation including the proposed response. For example, the recommendation may be displayed as an overlay within the VR environment 130 visible to the agent, although not visible to the user or others accessing the VR environment 130.

In these cases, the recommendations may direct the agent on how to respond to questions, statements, gestures, facial expressions, and/or other actions made by the user. For example, if server computing device 110 determines the user is becoming confused during an interaction with the agent, the generated recommendations may direct the agent to slow down and/or offer additional explanation. These recommendations may be generated using one or more chatbots and/or using AI programs such as ChatGPT. In some embodiments, if the user and agent speak different languages, server computing device 110 may provide translation in real time.

In the exemplary embodiment, when the agent is not present at the agent interface, server computing device 110 may cause that at least one avatar to perform the proposed response based upon a replicant persona associated with the agent. In such cases, the avatar may replicate the traits of the agent including, but not limited to, the mannerisms, appearance, personality, historical and conversational talking points. Actions or responses of the replicant persona may be generated using one or more chatbots and/or using AI programs such as ChatGPT. Accordingly, the avatar may act as a user interface for the business when the agent is not present or unavailable, with the avatar interacting with users to provide information about and to collect information for the business.

For instance, a replicant persona for an agent or other representative for a business may be created and stored. When a user in a virtual reality environment walks into the virtual reality representation of the business, the user is greeted by an avatar of the agent that can answer questions and potentially handle the user's request(s). In some embodiments, a new avatar (e.g., each representing the agent) may be generated to interact with each user. These could be multiple avatars each connected to different personas or multiple avatars with the same persona. Therefore, multiple users could be interacting with their own version of the avatar of the agent, simultaneously. This allows the business to provide a personal, singular engagement.

In a further example, an avatar generated to interact with a user may be trained to interact with the user within the metaverse in accordance with certain traits of the agent learned through virtual or actual interaction with the user. In one example, the traits of the agent may include the agent's body language, the agent's speaking accent and/or dialect observed from an initial interaction (real or virtual) with the agent for a specific training period (e.g., initial 5 minutes or 10 minutes). Additionally, or alternatively, the traits of the agent may be retrieved from a database in which the agent's profile and the traits of the agent are stored.

In some embodiments, the avatar may be interacting with the user to sell a new product or service (e.g., insurance products) for the user's newly purchased home or vehicle, or the avatar may be interacting with the user for a claim submitted by the user for an accident or a loss of a vehicle, or damage to the user's home, and so on. Accordingly, the avatar may be trained to show empathy, excitement, joy, kindness, or some other emotion that is appropriate with the cause of the interaction with the user. Additionally, or alternatively, certain traits or mannerisms of the avatar representing the agent, which may help to increase the user's confidence and trust in the product and/or service being marketed or sold by the avatar, may be used to train the avatar to incorporate those traits and/or mannerisms into the avatar during interaction with the user. In some cases, those traits or mannerisms incorporated into the agent's avatar may include similar traits and mannerism expressed by the user or the user's avatar.

In some embodiments, the avatar may initially be controlled by a live agent, for example, to respond to or greet the user, and/or to interact with the user to provide answers or information to the user. However, based upon the monitoring of the virtual interaction between the avatar being controlled by the real agent and the user, if it is determined that the interaction is not meeting a specific criterion, for example, the real agent's interactions with the user are not generating the desired responses or feedback from the user, the avatar may be controlled by an AI model or a machine-learning model to meet the specific criterion. For example, the real agent may be having a bad day, and, therefore, may be unable to show an appropriate level of empathy to the user while interacting with the user. Upon detecting such a condition or feedback from the user, server computing device 110 may control the avatar via the AI model or the ML model to adjust the level of empathy being presented to the user. Conversely, if is determined that a computer-controlled avatar is a specific criterion, server computing device 110 may alert a live agent to take control of the avatar.

In some examples, based upon an agent profile of the agent or historical interactions with the agent, if it is determined that the agent has a specific accent or dialect associated with a specific geographic location, the avatar may interact with the user using the specific accent or dialect. If it is learned that the agent frequently uses jokes, or one-liners while interacting, the avatar may be trained to use similar behavior while interacting with the user, which is likely to increase a comfort level of the user while interacting with the agent's avatar.

In addition, using a microphone and/or a camera, the agent's facial gestures, hand gestures, body language, and so on, may be recorded (e.g., while the agent is controlling the avatar live) and used for training the avatar to interact with the user in a specific way. An AI model or a machine-learning (ML) model may be used to train the avatar to identify which traits of the agent are beneficial to mimic or reproduce to increase the user's trust and confidence, and/or which traits of the agent may not be used by the avatar. The AI or ML model may also be used to train the avatar to use empathy corresponding to the cause of interaction with the avatar. For example, if the user has bought a new home or vehicle and is interacting with the avatar to purchase a new insurance policy, the avatar may use a happy or celebration tone while interacting with the user. Similarly, if the user is interacting with the avatar to report a damage or injury claim, the avatar may use a more supportive tone while interacting with the user.

The replicant persona, based upon which the avatar may be controlled, may be generated using one or more of Deep/Machine Learning (ML), Natural Language Processing (NLP), Voice Intelligence, and Artificial Intelligence (AI) to digitally replicate physical features and personality traits, mannerisms, voices, conversational style, quirks, interactions, facial expressions, hand gestures and/or other visible or audible mannerisms, and historical data and roles of the agent. The replicant persona is then used to generate one or more avatars to create unique and personalized experiences for users in a virtual reality or augmented reality space.

Data used to develop this replicant persona may include, but is not limited to, all available interactions from movies, videos, social media posts, interviews, recordings, images, scripts, other sources where a person's (e.g., an agent's) true personality and style could ultimately be captured, and/or current or previous interactions with the user. These data points could then be synthesized by deep/machine learning and cognitive computing and AI Voice subfields to accurately represent the agent and how they might respond given certain inputs and scenarios while interacting with the user.

The replicant persona can be used to generate individual avatars for different interactions. In some further embodiments, the individual avatar may be loaded with or have access to information about the individual user that the avatar is interacting with. For example, the avatar may know the user's name and call them by name directly. In a business interaction, the avatar may know additional information about the user, up to and including account details and/or other private or personally identifiable information.

In some embodiments, where the person (e.g., agent) to be represented by the avatar is available, server computing device 110 may use a 3-D indexing tool to scan the agent. The 3-D indexing tool may scan and capture the physical essence of the agent including, but not limited to physical attributes, tattoos, hair style, make-up, clothing, and other interesting aspects of the agent to use with an avatar that interacts with the user.

In some examples, a user may use his/her user avatar to interact with the virtual reality environment, including interacting with other user avatars in the environment. While a user avatar represents the individual user on a one-to-one basis, a replicant persona can have multiple avatars executing simultaneously in different areas of the virtual reality. For example, a first user may be in a virtual room with a first avatar of the replicant persona, while a second user is in a separate virtual room with a second avatar of the same replicant persona. The first user and the second user are able to separately and simultaneously interact with their own avatar of the replicant person.

In the exemplary embodiment, server computing device 110 may provide for a secure exchange of documents and/or other data using a virtual lockbox mechanism. The virtual lockbox may enable a user to securely store documents and to authorize other users to access the documents. For example, a user may, through input (e.g., within virtual environment 130, a mobile app, and/or web page) designate documents (e.g., insurance policy documents, insurance cards, and/or documents and/or other data relating to insurance claims) to be stored in the virtual lockbox, or the documents may automatically be stored in association with the virtual lockbox in response to certain events (e.g., purchase or renewal of an insurance policy and/or filing of an insurance claim). The user may also designate other users (e.g., agents, other individuals involved in an insurance claim) to access any of these stored documents, or server computing device 110 may determine which individuals to authorize access to certain documents stored within the virtual lockbox. These authorized users may then retrieve, view, and/or trigger a download of these documents, for example, by accessing the virtual lockbox within virtual environment 130. In embodiments in which the virtual lockbox includes insurance-related documents, such access enables authorized users to quickly access these documents and determine insurance coverage in real time in case of an accident or other insurance-related event.

The lockbox may be implemented using a database structure. For example, each lockbox may be defined by a lockbox identifier in database 120 and be stored in association with other information such as an associated user and/or user identifier, user preferences, documents, and information about permissions to access documents, as described in further detail below. The lockbox identifier may be further associated with the virtual representation of the lockbox within the virtual environment. Thus, the information associated with the lockbox identifier may be accessed or modified based upon detected interactions within the virtual environment as described in further detail below.

In the exemplary embodiment, server computing device 110 may be configured to communicate with one or more user devices to cause those user devices to present virtual environment 130 to include at least one virtual lockbox associated with a first user. In some embodiments, the virtual lockbox may appear similar to an actual lockbox or any other item (e.g., a safe or a file cabinet) users would likely understand to indicate a secure place to store documents. Alternatively, the virtual lockbox may appear as any other type of item, point, or node within virtual environment 130 labeled as such (e.g., an icon or button). As described above, each user may have a corresponding user avatar, which may interact with the virtual lockbox within virtual environment 130 analogously to how a person may interact with a lockbox in real life (e.g., opening or closing and/or depositing or withdrawing documents). As described in further detail below, access to and/or the appearance of the lockbox to a particular user may be controlled based upon whether the particular user is authorized to access any documents stored in the virtual lockbox. Within virtual environment 130, the virtual lockbox may include and/or be labeled with text or indicators providing information about the virtual lockbox (e.g., which user is associated with the lockbox, a relationship between the viewer and the user is associated with the lockbox, and/or whether the viewer has access to any documents in the virtual lockbox). For example, the lockbox may include a lock that requires a combination or code to be entered to allow a user to access documents included within the lockbox. A different code may be tied to the different documents included with in the virtual lockbox such that when a code is entered only the documents linked to that code are shown and are accessible by that user.

In the exemplary embodiment, server computing device 110 may be configured to store one or more documents in the memory in association with the virtual lockbox. For example, the user may designate documents to store in association with the virtual lockbox or server computing device 110 may automatically determine and store, or suggest to store, documents in association with the virtual lockbox. In some embodiments, the user may input instructions at a mobile device via a mobile application instructing the system to store documents in association with the at least one virtual lockbox. Server computing device 110 may then store the one or more documents in association with the at least one virtual lockbox in response to receiving the instruction. In some embodiments, the user may generate user input data (e.g., by making corresponding movements and gestures) with the user device that indicates an intention to store the one or more documents in association with the virtual lockbox (e.g., dragging and placing, or selecting from a menu). Server computing device 110 may then store the one or more documents in association with the virtual lockbox in response to receiving this user input data. In some embodiments, server computing device 110 may automatically identify documents to store. For example, server computing device 110 may identify any insurance policy document, insurance cards, and/or insurance claim documents that are associated with the user, and may automatically store the documents or generate recommendations for the user to store the documents in the virtual lockbox.

In the exemplary embodiment, server computing device 110 may be configured to identify one or more authorized users of the plurality of users to enable access to the at least one virtual lockbox. In some embodiments, the user associated with the lockbox may select other users to receive authorization. For example, the user may submit instructions at the mobile device via the mobile application instructions to designate one or more users as authorized to access the one or more documents, and server computing device 110 may identify one or more authorized users based upon the received instruction. The user may submit similar instructions through another channel, such as through interaction within virtual environment 130 itself and/or through another computing device. In some embodiments, server computing device 110 may automatically determine who should have access to the virtual lock box. For example, server computing device 110 may identify any agents associated with the user and/or any other individuals involved in claims submitted by the user (e.g., other parties of an accident, other insurers, police officers, repair technicians, etc.) as authorized to access one or more of the documents stored in association with the virtual lockbox.

In the exemplary embodiment, server computing device 110 may be configured to provide access to the one or more documents in response to the identified one or more authorized users interacting with the virtual lockbox in virtual environment 130. For example, the authorized users may open, click or tap on, or otherwise interact with the virtual lockbox in virtual environment 130, which may enable the authorized users to view of download the documents. In some embodiments, the documents may be viewed within virtual environment 130. Additionally or alternatively, accessing the documents in virtual environment 130 may trigger a download or other transfer of data that enables the documents to be viewed through a different channel, such as through the mobile app, web page, and/or another type of file-viewing application.

For example, one or more predefined gestures and/or other actions (e.g., verbal statements) may be stored. When one of these gestures or other actions, for example, motion consistent with opening a virtual representation of the virtual lockbox within the virtual environment, are detected by server computing device 110 and/or virtual realter server 125 when a user is within appropriate proximity to the virtual lockbox within virtual environment 130, server computing device 110 may determine if the user has permission to retrieve any of the documents stored in database 120 in association with the corresponding lockbox identifier based upon the permissions information associated with the corresponding lockbox identifier. If so, the user may initiate retrieval and viewing of any of these documents from database 120 by making further corresponding gestures and/or other actions.

In the exemplary embodiment, server computing device 110 may provide for a real time accident support in virtual environment 130. Server computing device 110 may receive sensor data from the user devices (e.g., data captured by smart glasses), which may be used to determine if an accident (e.g., a vehicular collision or other incident resulting in injury and/or property damage) has occurred. In response to detecting an accident and/or receiving input from the user (e.g., as a voice command) that an accident has occurred, server computing device 110 may prompt the user to interact with a live agent and/or replicant persona in virtual environment 130 as described above.

Server computing device 110 may provide guidance and/or instructions to the user via the user device, for example, as prompts displayed within virtual environment 130 and/or instructions provided by an agent avatar. These prompts may include text or speech (e.g., speech associated with the virtual avatars described above). The prompts may include questions verifying that the user is not injured or to provide information about what has occurred. For example, the prompts may instruct the user to take pictures and/or ask questions to others present at the scene of the accident.

The user device may also passively collect data, such as image and/or audio data, in response to the accident being detected. This collected information may be used to determine if additional resources, such as emergency personnel or insurance personnel, need to be contacted, and automatically initiate such contact (e.g., by initiating an emergency “9-1-1” call and/or presenting an agent avatar within virtual environment 130 as described above). The collected information may further be used to generate digital twins, simulations, and/or visual reconstructions of the accident, which may be used to determine an extent of damage or injury that has occurred and the cause of the accident, such as which vehicle or vehicle system was at fault for the accident. In some embodiments, these reconstructions may be viewed within virtual environment 130.

In the exemplary embodiment, server computing device 110 may be configured to receive sensor data from the user devices. For example, at least some of the user device may include cameras, microphones, motion sensors (e.g., accelerometers and/or gyroscopes), location sensors (e.g., GPS), radar, lidar, and/or any other types of sensors. This data may be received (e.g., continuously or periodically) prior to, during, and following an accident. As described in further detail below, this senor data may be used by server computing device 110 to determine when an accident has occurred and to gather information about the nature, scene, context, and results of the accident.

In the exemplary embodiment, server computing device 110 may be further configured to determine, based upon the received sensor data, that an accident has occurred. In some embodiments, this determination may be made by analyzing audio, video, and/or motion data, for example, using AI and/or ML techniques and/or by comparing such data to one or more predefined thresholds indicative that an accident has occurred (e.g., a vehicle decelerating more quickly that would be possible using the brakes).

Such models may be trained using historical sensor data and corresponding outcomes. For example, historical patterns of sensor data may be associated with accident events. The model may use these historical associations to identify patterns of sensor data that are likely associated with an accident and predict that an accident has occurred based upon received sensor data. For example, the model may generate thresholds (e.g., values associated with vehicle movement) or profiles (e.g., speech patterns) that are associated with an occurrence of an accident and server computing device 110 may compare received sensor data to these thresholds and/or profiles. In certain embodiments, this model may be built and/or trained by server computing device 110, and may be updated and/or retrained over time as additional sensor data becomes available.

In some embodiments, the determination may be made based upon detected voice, speech, facial expressions, and/or gestures made by the user or other individuals in the area. For example, in some embodiments, server computing device 110 may utilize specific voice commands or phrases made by the user (e.g., saying “in an accident”) to determine an accident has occurred and initiate an appropriate response. Additionally, or alternatively, server computing device 110 may analyze non-structured speech or voice (e.g., using AI and/or chatbots) to determine that the non-structured speech or voice indicates an accident has occurred. When it is determined an accident has occurred, the user may be alerted to launch or access virtual environment 130 via the user device using voice commands.

In some embodiments, server computing device 110 may configured to detect one or more voice commands input by the first user to the first user device. As described above, some of these voice commands may relate to an indication that an accident has occurred. Additionally, the voice commands may request specific actions, such as contacting an agent (e.g., by saying “contact my agent”) or calling emergency services (e.g., by saying “call 9-1-1”). Server computing device 110 may analyze these voice commands (e.g., using AI and/or chatbots and/or by performing a lookup based upon the received speech) to determine an appropriate response. For example, saying “contact my agent” may brings the agent, agent staff, agent machine learning bot/avatar or replicant persona, or claim representative into the metaverse channel for discussion or other interaction with the user. For example, server computing device 110 may present within the virtual environment to an agent using an agent device of the user devices, a prompt to communicate with the user within the virtual environment.

As described above, server computing device 110 may generate responses to be performed by avatars and/or recommended to live agents and/or other agent personnel, and may retrieve relevant policy documents for review by the agent. In some embodiments, server computing device 110 may determine to perform these actions (e.g., contacting emergency personnel) even without a specific voice command. For example, if server computing device 110 determines a sufficiently severe accident has occurred, server computing device 110 may automatically contact emergency personnel through an appropriate channel to request assistance and/or provide relevant information (e.g., a location of the accident and/or identities of persons involved).

In the exemplary embodiment, in response to determining the accident has occurred, server computing device 110 may be configured to present within virtual environment 130 one or more prompts for collecting information relating to the accident using the user device. The prompts may be presented as text, audible commands, and/or statements made by avatars within virtual environment 130. Examples of such prompts may include instructions to take pictures of the accident scene and where and/or questions to ask others at the scene of the accident. In some embodiments, these prompts may be generated using AI and/or chatbot technology, for example, to gather as much information as possible relevant to completing an insurance claim. Server computing device 110 may record interactions or other information resulting from the user following these instructions. This information, such as the captured pictures and/or statements made by others at the scene of the accident (e.g., witness accounts of what happened, statements indicating what happened or indications innocence, contact information, etc.), may be transmitted by the user device back to server computing device 110 to be recorded and/or analyzed further.

In some embodiments, server computing device 110 may automatically identify other individuals at the scene of the accident. For example, server computing device 110 may detect one or more devices proximate to the user device (e.g., using Bluetooth device identification and/or another appropriate form of wireless communication), and may perform a lookup to identify individuals present at a scene of the accident based upon the detected one or more devices. In some embodiments, server computing device 110 may identify individuals based upon detecting and analyzing voices of or statements made by the individuals detected by the user device.

In the exemplary embodiment, server computing device 110 may be further configured to generate an accident profile including the information collected by the user using the first user device in response to the one or more prompts. The accident profile may be a database, database component, and/or data structure (e.g., stored in database 120) that stores various types of information associated with the accident. In addition to the sensor data and information gathered by the user associated with the accident, other relevant data may be recorded in association with the accident profile, such as a date, time, location, weather, traffic, maps, geographic models or vehicle models, and/or other data associated with or providing context to the accident. In some embodiments, server computing device 110 may retrieve additional documents, such as a police report, insurance policy documents, insurance claim documents, and/or estimates or receipts from mechanics associated with the accident and store these documents in association with the accident profile.

In some embodiments, server computing device 110 may generate one or more digital twins representing people, vehicles, or other objects involved in the accident and/or a visual representation and/or reconstruction of the accident based upon information included in the accident profile. For example, server computing device 110 may parse the accident profile for sensor data, speech data, and/or documents relating to the accident to identify positions and orientations of relevant people and objects during the course of the accident. In some embodiments, AI and/or ML techniques may be utilized for such parsing. In some embodiments, server computing device 110 the visual representation may be presented within virtual environment 130, so that agents or others reviewing the accident may do so in a three-dimensional environment.

### Exemplary Client Device

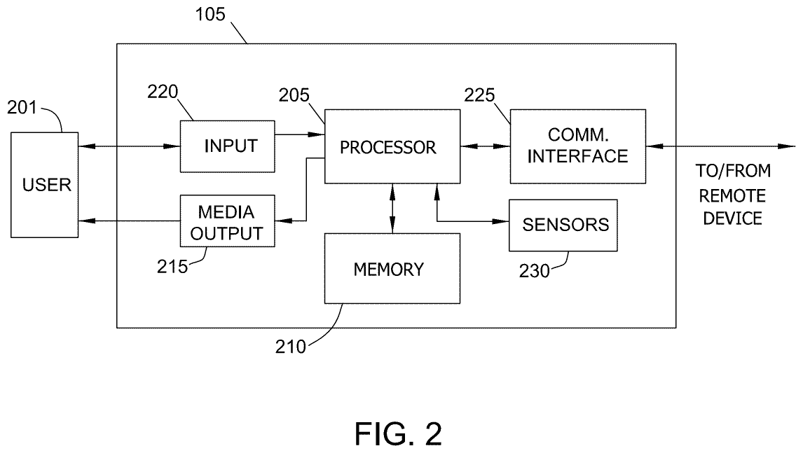

FIG. 2 depicts an exemplary configuration of a client computer device 105 shown in FIG. 1, in accordance with one embodiment of the present disclosure. Client computing device 105 may be operated by a user 201. Client computing device 105 may include a processor 205 for executing instructions. In some embodiments, executable instructions are stored in a memory area 210. Processor 205 may include one or more processing units (e.g., in a multi-core configuration). Memory area 210 may be any device allowing information such as executable instructions and/or transaction data to be stored and retrieved. Memory area 210 may include one or more computer readable media.

Client computing device 105 may also include at least one media output component 215 for presenting information to user 201. Media output component 215 may be any component capable of conveying information to user 201. In some embodiments, media output component 215 may include an output adapter (not shown) such as a video adapter and/or an audio adapter. An output adapter may be operatively coupled to processor 205 and operatively couplable to an output device such as a display device (e.g., a cathode ray tube (CRT), liquid crystal display (LCD), light emitting diode (LED) display, or “electronic ink” display), an audio output device (e.g., a speaker or headphones), virtual headsets (e.g., AR (Augmented Reality), VR (Virtual Reality), or XR (extended Reality) headsets).

In some embodiments, media output component 215 may be configured to present a graphical user interface (e.g., a web browser and/or a client application) to user 201. A graphical user interface may include, for example, an online store interface for viewing and/or purchasing items, and/or a wallet application for managing payment information. In some embodiments, client computing device 105 may include an input device 220 for receiving input from user 401. User 201 may use input device 220 to, without limitation, select and/or enter one or more items to purchase and/or a purchase request, or to access credential information, and/or payment information.

Input device 220 may include, for example, a keyboard, a pointing device, a mouse, a stylus, a touch sensitive panel (e.g., a touch pad or a touch screen), a gyroscope, an accelerometer, a position detector, a biometric input device, an audio input device (e.g., a microphone), and/or a video input device (e.g., a camera). A single component such as a touch screen may function as both an output device of media output component 215 and input device 220.

Client computing device 105 may also include a communication interface 225, communicatively coupled to a remote device such as server computing device 110 (shown in FIG. 1). Communication interface 225 may include, for example, a wired or wireless network adapter and/or a wireless data transceiver for use with a mobile telecommunications network.

Stored in memory area 210 are, for example, computer readable instructions for providing a user interface to user 201 via media output component 215 and, optionally, receiving and processing input from input device 220. A user interface may include, among other possibilities, a web browser and/or a client application. Web browsers enable users, such as user 201, to display and interact with media and other information typically embedded on a web page or a website from the server computing device 110 and/or the virtual reality server 125. A client application allows user 201 to interact with, for example, the server computing device 110 and/or the virtual reality server 125. For example, instructions may be stored by a cloud service, and the output of the execution of the instructions sent to the media output component 215.

Processor 205 executes computer-executable instructions for implementing aspects of the disclosure. In some embodiments, the processor 205 is transformed into a special purpose microprocessor by executing computer-executable instructions or by otherwise being programmed.

### Exemplary Server Device

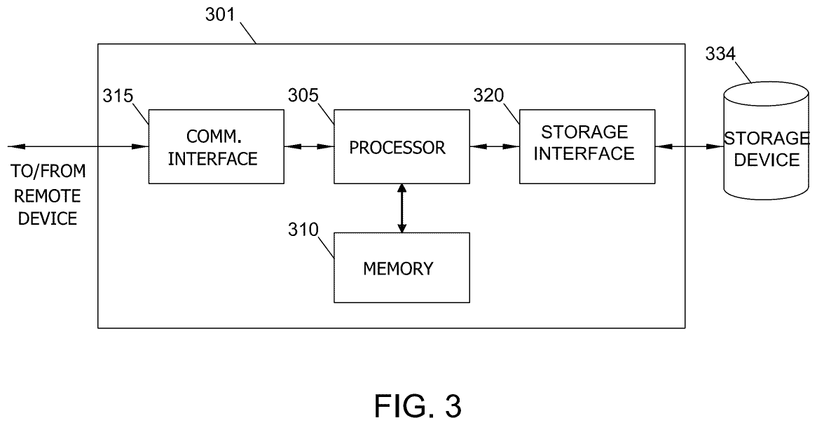

FIG. 3 depicts an exemplary configuration of a server computing device 301, in accordance with one embodiment of the present disclosure. Server computer device 301 may include, but is not limited to, server computing device 110 and/or virtual reality server 125 (all shown in FIG. 1). Server computer device 301 may also include a processor 305 for executing instructions. Instructions may be stored in a memory area 310. Processor 305 may include one or more processing units (e.g., in a multi-core configuration).

Processor 305 may be operatively coupled to a communication interface 515 such that server computer device 301 is capable of communicating with a remote device such as another server computer device 301, virtual reality server 125, or client computer devices 105 (shown in FIGS. 1 and 2). For example, communication interface 315 may receive requests from client computer devices 105 via the Internet.

Processor 305 may also be operatively coupled to a storage device 134. Storage device 334 may be any computer-operated hardware suitable for storing and/or retrieving data, such as, but not limited to, data associated with database 120 (shown in FIG. 1). In some embodiments, storage device 334 may be integrated in server computer device 301. For example, server computer device 301 may include one or more hard disk drives as storage device 334.

In other embodiments, storage device 334 may be external to server computer device 301 and may be accessed by a plurality of server computer devices 301. For example, storage device 534 may include a storage area network (SAN), a network attached storage (NAS) system, and/or multiple storage units such as hard disks and/or solid state disks in a redundant array of inexpensive disks (RAID) configuration.

In some embodiments, processor 305 may be operatively coupled to storage device 334 via a storage interface 320. Storage interface 320 may be any component capable of providing processor 305 with access to storage device 334. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 334.

Processor 305 may execute computer-executable instructions for implementing aspects of the disclosure. In some embodiments, the processor 305 may be transformed into a special purpose microprocessor by executing computer-executable instructions or by otherwise being programmed.

### Exemplary Computer-Implemented Method for Interaction in a Virtual Environment

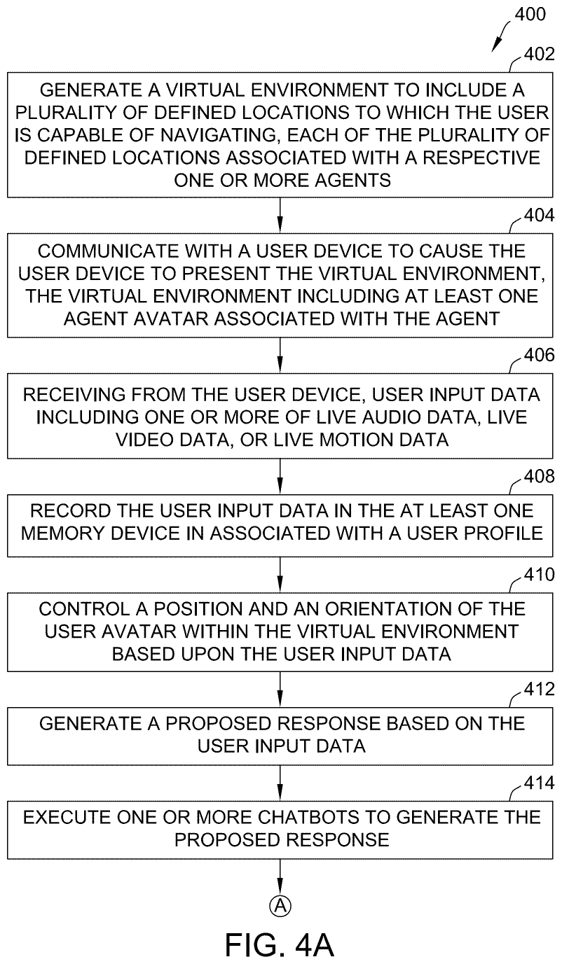

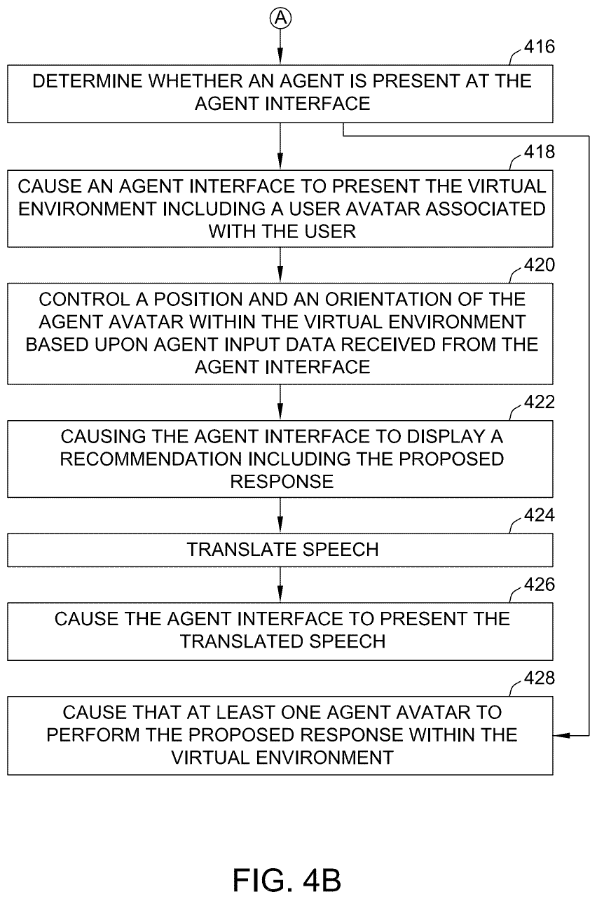

FIGS. 4A and 4B depicts a flow chart of an exemplary computer-implemented process 400 for interaction with at least one user in a virtual environment using the system 100 shown in FIG. 1. Process 400 may be implemented by a computing device, for example server computing device 110 and/or virtual reality server 125 (shown in FIG. 1). In the exemplary embodiment, server computing device 110 may be in communication with one or more virtual reality servers 125 and one or more client computer devices 105 (both shown in FIG. 1).

In some embodiments, process 400 may include generating (Block 402) the virtual environment to include a plurality of defined locations to which the user is capable of navigating, each of the plurality of defined locations associated with a respective one or more agents. In some embodiments, this action or operation may be performed by server computing device 110 and/or virtual reality server 125 (shown in FIG. 1).

In the exemplary embodiment, process 400 may include communicating (Block 404) with the user device to cause the user device to present the virtual environment, the virtual environment including at least one agent avatar associated with the agent. In some embodiments, this action or operation may be performed by server computing device 110 and/or virtual reality server 125 (shown in FIG. 1).

In the exemplary embodiment, process 400 may further include receiving (Block 406), from the user device, user input data including one or more of live audio data, live video data, or live motion data. In some embodiments, this action or operation may be performed by server computing device 110 and/or virtual reality server 125 (shown in FIG. 1).

In some embodiments, process 400 may further include recording (Block 408) the user input data in the at least one memory device in association with a user profile. In some embodiments, this action or operation may be performed by server computing device 110 and/or virtual reality server 125 (shown in FIG. 1).

In some embodiments, process 400 may further include controlling (Block 410) a position and an orientation of the user avatar within the virtual environment based upon the user input data. In some embodiments, this action or operation may be performed by server computing device 110 and/or virtual reality server 125 (shown in FIG. 1).

In the exemplary embodiment, process 400 may further include generating (Block 412) a proposed response based upon the user input data. In some embodiments, this action or operation may be performed by server computing device 110 and/or virtual reality server 125 (shown in FIG. 1). In certain embodiments, the proposed response may be generated using an AI model trained based upon historical interaction data (e.g., historical real or simulated interactions between users corresponding outcomes within VR environment 130). In such embodiments, server computing device 110 and/or virtual reality server 125 may train the AI model using the historical interaction data or retrieve an AI model trained at another location.

In some embodiments, process 400 may further include executing (Block 414) one or more chatbots to generate the proposed response. In some embodiments, this action or operation may be performed by server computing device 110 and/or virtual reality server 125 (shown in FIG. 1).

In the exemplary embodiment, process 400 may further include determining (Block 416) whether an agent is present at the agent interface. In some embodiments, this action or operation may be performed by server computing device 110 and/or virtual reality server 125 (shown in FIG. 1).

In some embodiments, process 400 may further include causing (Block 418) the agent interface to present the virtual environment including a user avatar associated with the user. In some embodiments, this action or operation may be performed by server computing device 110 and/or virtual reality server 125 (shown in FIG. 1).

In some embodiments, process 400 may further include controlling (Block 420) a position and an orientation of the agent avatar within the virtual environment based upon agent input data received from the agent interface. In some embodiments, this action or operation may be performed by server computing device 110 and/or virtual reality server 125 (shown in FIG. 1).

In the exemplary embodiment, process 400 may further include, when the agent is present at the agent interface, causing (Block 422) the agent interface to display a recommendation including the proposed response. In some embodiments, this action or operation may be performed by server computing device 110 and/or virtual reality server 125 (shown in FIG. 1).

In some embodiments, the user input data includes speech, and process 400 further includes, when the agent is present at the agent interface, translating (Block 424) the speech. In such embodiments, process 400 may further include causing 426 the agent interface to present the translated speech. In some embodiments, this action or operation may be performed by server computing device 110 and/or virtual reality server 125 (shown in FIG. 1).

In the exemplary embodiment, process 400 further includes, when the agent is not present at the agent interface, causing (Block 428) that at least one agent avatar to perform the proposed response within the virtual environment. In some embodiments, this action or operation may be performed by server computing device 110 and/or virtual reality server 125 (shown in FIG. 1).

### Exemplary Computer-Implemented Method for Generating an Avatar

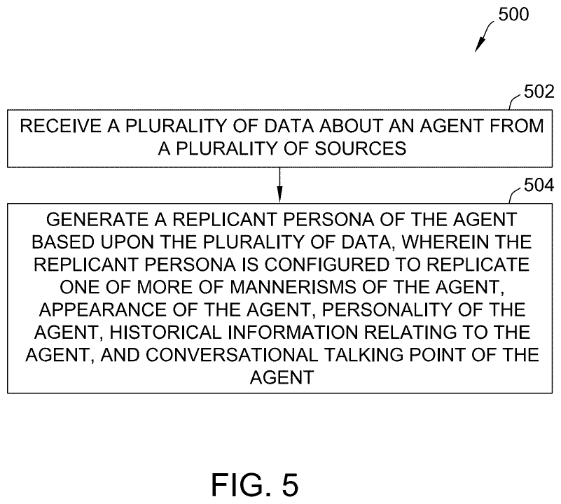

FIG. 5 depicts a flow chart of an exemplary computer-implemented process 500 for generating an avatar for an agent or other individual using system 100 shown in FIG. 1. Process 500 may be implemented by a computing device, for example server computing device 110 and/or virtual reality server 125 (shown in FIG. 1). In the exemplary embodiment, server computing device 110 may be in communication with one or more virtual reality servers 125 and one or more client computer devices 105 (both shown in FIG. 1).

In the exemplary embodiment, process 500 may include receiving (Block 502) a plurality of data about the agent from a plurality of sources. In some embodiments, this action or operation may be performed by server computing device 110 and/or virtual reality server 125 (shown in FIG. 1).

In the exemplary embodiment, process 500 may include generating (Block 504) a replicant persona of the agent based upon the plurality of data, wherein the replicant persona is configured to replicate one or more of mannerisms of the agent, appearance of the agent, personality of the agent, historical information relating to the agent, and conversational talking points of the agent. The proposed response referred to with respect to process 400 (shown in FIGS. 4A and 4B) may be generated based at least in part upon the replicant persona. In some embodiments, the mannerisms of the agent may include one or more of: hand gestures of the agent, facial gestures of the agent, body language of the agent, a speaking accent of the agent, a dialect of the agent, a personality of the agent, or emotions of the agent. In some embodiments, the plurality of data includes social media, behavior data from interviews, recordings, images, and/or historical data about the agent. In some embodiments, this action or operation may be performed by server computing device 110 and/or virtual reality server 125 (shown in FIG. 1).

### Exemplary Computer-Implemented Method for Providing Secure Data Exchange in a Virtual Environment

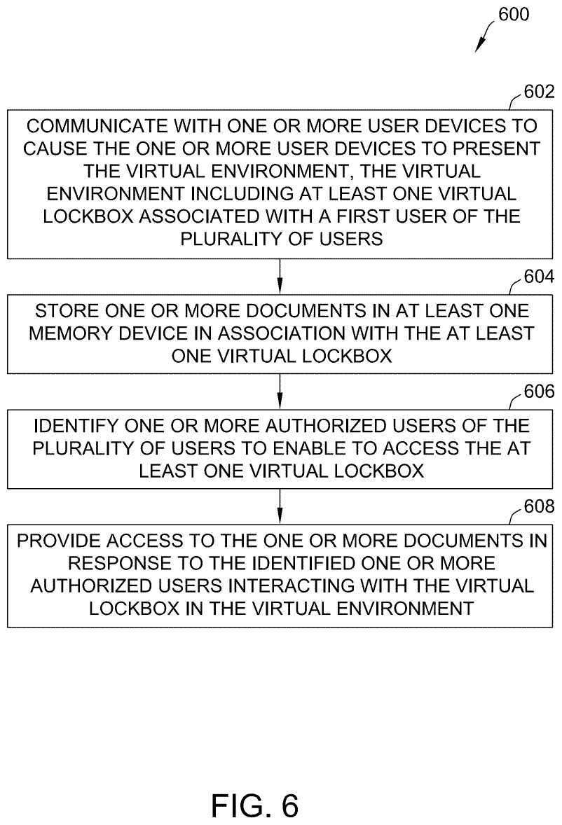

FIG. 6 depicts a flow chart of an exemplary computer-implemented process 600 for providing secure data exchange in a virtual environment such as virtual environment 130 using system 100 shown in FIG. 1. Process 600 may be implemented by a computing device, for example server computing device 110 and/or virtual reality server 125 (shown in FIG. 1). In the exemplary embodiment, server computing device 110 may be in communication with one or more virtual reality servers 125 and one or more client computer devices 105 (both shown in FIG. 1).

In the exemplary embodiment, process 600 may include communicating (Block 602) with the one or more user devices to cause the one or more user devices to present the virtual environment, the virtual environment including at least one virtual lockbox associated with a first user of the plurality of users. In some embodiments, this action or operation may be performed by server computing device 110 and/or virtual reality server 125 (shown in FIG. 1).

In the exemplary embodiment, process 600 may further include storing (Block 604) one or more documents in the at least one memory device in association with the at least one virtual lockbox. In some embodiments, this action or operation may be performed by server computing device 110 and/or virtual reality server 125 (shown in FIG. 1).

In the exemplary embodiment, process 600 may further include identifying (Block 606) one or more authorized users of the plurality of users to enable access to the at least one virtual lockbox. In some embodiments, this action or operation may be performed by server computing device 110 and/or virtual reality server 125 (shown in FIG. 1).

In the exemplary embodiment, process 600 may further include providing access (Block 608) to the one or more documents in response to the identified one or more authorized users interacting with the virtual lockbox in the virtual environment. In some embodiments, this action or operation may be performed by server computing device 110 and/or virtual reality server 125 (shown in FIG. 1).

### Exemplary Computer-Implemented Method for Providing Real Time Accident Support in a Virtual Environment

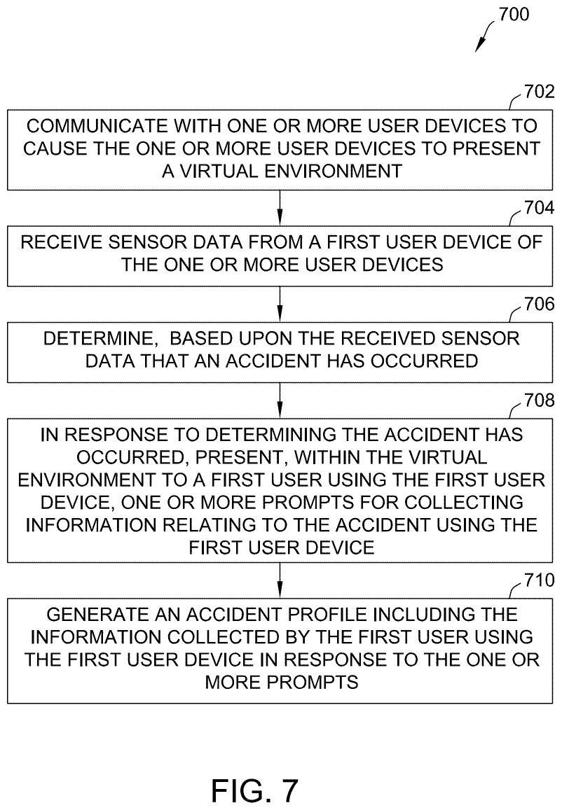

FIG. 7 depicts a flow chart of an exemplary computer-implemented process 700 for providing real time accident support in a virtual environment such as virtual environment 130 using system 100 shown in FIG. 1. Process 700 may be implemented by a computing device, for example server computing device 110 and/or virtual reality server 125 (shown in FIG. 1). In the exemplary embodiment, server computing device 110 may be in communication with one or more virtual reality servers 125 and one or more client computer devices 105 (both shown in FIG. 1).

In the exemplary embodiment, process 700 may include communicating (Block 702) with one or more user devices to cause the one or more user devices to present a virtual environment. In some embodiments, this action or operation may be performed by server computing device 110 and/or virtual reality server 125 (shown in FIG. 1).

In the exemplary embodiment, process 700 may further include receiving (Block 704) sensor data from a first user device of the one or more user devices. In some embodiments, this action or operation may be performed by server computing device 110 and/or virtual reality server 125 (shown in FIG. 1).

In the exemplary embodiment, process 700 may further include determining (Block 706), based upon the received sensor data, that an accident has occurred. In some embodiments, this action or operation may be performed by server computing device 110 and/or virtual reality server 125 (shown in FIG. 1). In certain embodiments, the determination may be made using an AI model trained based upon historical sensor data. In such embodiments, server computing device 110 and/or virtual reality server 125 may train the AI model using the historical sensor data or retrieve an AI model trained at another location.

In the exemplary embodiment, process 700 may further include, in response to determining the accident has occurred, presenting (Block 708), within the virtual environment to a first user using the first user device, one or more prompts for collecting information relating to the accident using the first user device. In some embodiments, this action or operation may be performed by server computing device 110 and/or virtual reality server 125 (shown in FIG. 1).

In the exemplary embodiment, process 700 may further include generating (Block 710) an accident profile including the information collected by the first user using the first user device in response to the one or more prompts. In some embodiments, this action or operation may be performed by server computing device 110 and/or virtual reality server 125 (shown in FIG. 1).

### Exemplary Embodiments & Functionality

In one aspect, a computer system for generating a virtual reality replicant persona for interaction with at least one user may be provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT or ChatGPT-based bots, and/or other electronic or electrical components, which may be in wired or wireless communication with one another. For example, in one instance, the computer system may include at least one local or remote processor and/or associated transceiver in communication with at least one local or remote memory device and in communication with a user device associated with a user and with an agent interface associated with an agent. The at least one processor may be programmed to: (1) communicate with the user device to cause the user device to present the virtual environment, the virtual environment including at least one agent avatar associated with the agent; (2) receive, from the user device, user input data including one or more of live audio data, live video data, or live motion data; (3) generate a proposed response based upon the user input data; (4) determine whether an agent is present at the agent interface; (5) when the agent is present at the agent interface, cause the agent interface to display a recommendation including the proposed response; and/or (6) when the agent is not present at the agent interface, cause that at least one agent avatar to perform the proposed response within the virtual environment. The computer system may have additional, less, or alternate functionality, including that discussed elsewhere herein.

In an enhancement, the at least one processor may be further configured to cause the agent interface to present the virtual environment including a user avatar associated with the user.

In a further enhancement, the at least one processor may be further configured to control a position and an orientation of the user avatar within the virtual environment based upon the user input data.

In another further enhancement, the at least one processor may be further configured to control a position and an orientation of the agent avatar within the virtual environment based upon agent input data received from the agent interface, the agent input data including one or more of live audio data, live video data, or live motion data.

In another enhancement, the at least one processor may be further configured to receive a plurality of data about the agent from a plurality of sources and generate a replicant persona of the agent based upon the plurality of data, wherein the replicant persona is configured to replicate one or more of mannerisms of the agent, appearance of the agent, personality of the agent, historical information relating to the agent, and conversational talking points of the agent, and wherein the proposed response is generated based at least in part upon the replicant persona.

In a further enhancement, the one or more mannerisms of the agent may include one or more of: hand gestures of the agent, facial gestures of the agent, body language of the agent, a speaking accent of the agent, a dialect of the agent, a personality of the agent, and/or emotions of the agent.

In another further enhancement, the plurality of data may include social media, behavior data from interviews, recordings, images, and/or historical data about the agent.

In another enhancement, the at least one processor may be further configured to execute one or more chatbots to generate the proposed response.

In another enhancement, the at least one processor may be further configured to record the user input data in the at least one memory device in association with a user profile.

In another enhancement, the at least one processor may be further configured to generate the virtual environment to include a plurality of defined locations to which the user is capable of navigating, each of the plurality of defined locations associated with a respective one or more agents.

In a further enhancement, the user input data may include speech, and the at least one processor may be configured to, when the agent is present at the agent interface, translate the speech and cause the agent interface to present the translated speech within the virtual environment.

In another enhancement, the at least one processor may be further configured to generate the proposed response using an artificial intelligence model trained based upon historical interaction data.

In a further enhancement, the at least one processor may be further configured to train the artificial intelligence model using the historical interaction data.

In another aspect, a computer-based or computer-implemented method for generating a virtual reality replicant persona for interaction with at least one user may be provided. The method may be implemented by a computer system including any of the electronic or electrical components discussed herein. For instance, the method may be implemented by at least one processor in communication with at least one memory device and in communication with a user device associated with a user and with an agent interface associated with an agent. The method may include: (1) communicating with the user device to cause the user device to present the virtual environment, the virtual environment including at least one agent avatar associated with the agent; (2) receiving, from the user device, user input data including one or more of live audio data, live video data, or live motion data; (3) generating a proposed response based upon the user input data; (4) determining whether an agent is present at the agent interface; (5) when the agent is present at the agent interface, causing the agent interface to display a recommendation including the proposed response; and/or (6) when the agent is not present at the agent interface, causing that at least one agent avatar to perform the proposed response within the virtual environment. The method may include additional, less, or alternate actions, including those discussed elsewhere herein.

In an enhancement, the computer-implemented method may further include causing the agent interface to present the virtual environment including a user avatar associated with the user.

In a further enhancement, the computer-implemented method may further include controlling a position and an orientation of the user avatar within the virtual environment based upon the user input data.

In another further enhancement, the computer-implemented method may further include controlling a position and an orientation of the agent avatar within the virtual environment based upon agent input data received from the agent interface, the agent input data including one or more of live audio data, live video data, or live motion data.

In another enhancement, the computer-implemented method may further include receiving a plurality of data about the agent from a plurality of sources and generating a replicant persona of the agent based upon the plurality of data, wherein the replicant persona is configured to replicate one or more of mannerisms of the agent, appearance of the agent, personality of the agent, historical information relating to the agent, and conversational talking points of the agent, and wherein the proposed response is generated based at least in part upon the replicant persona.

In a further enhancement, the one or more mannerisms of the agent may include one or more of: hand gestures of the agent, facial gestures of the agent, body language of the agent, a speaking accent of the agent, a dialect of the agent, a personality of the agent, and/or emotions of the agent.

In another further enhancement, the plurality of data may include social media, behavior data from interviews, recordings, images, and/or historical data about the agent.

In another enhancement, the computer-implemented method may further include executing one or more chatbots to generate the proposed response.

In another enhancement, the computer-implemented method may further include recording the user input data in the at least one memory device in association with a user profile.

In another enhancement, the computer-implemented method may be further include generating the virtual environment to include a plurality of defined locations to which the user is capable of navigating, each of the plurality of defined locations associated with a respective one or more agents.

In a further enhancement, the user input data may include speech, and the computer-implemented method may further include, when the agent is present at the agent interface, translating the speech and causing the agent interface to present the translated speech within the virtual environment.

In another enhancement, the computer-implemented method may further include generating the proposed response using an artificial intelligence model trained based upon historical interaction data.

In a further enhancement, the computer-implemented method may further include training the artificial intelligence model using the historical interaction data.

In yet another aspect, at least one non-transitory computer-readable media having computer-executable instructions embodied thereon is disclosed, the computer-executable instructions when executed by a computer system including at least one processor in communication with at least one memory device and in communication with a user device associated with a user and with an agent interface associated with an agent, the computer-executable instructions cause the at least one processor to: (1) communicate with the user device to cause the user device to present the virtual environment, the virtual environment including at least one agent avatar associated with the agent; (2) receive, from the user device, user input data including one or more of live audio data, live video data, or live motion data; (3) generate a proposed response based upon the user input data; (4) determine whether an agent is present at the agent interface; (5) when the agent is present at the agent interface, cause the agent interface to display a recommendation including the proposed response; and/or (6) when the agent is not present at the agent interface, cause that at least one agent avatar to perform the proposed response within the virtual environment. The computer-executable instructions may direct additional, less, or alternate functionality, including that discussed elsewhere herein.

In an enhancement, the computer-executable instructions may further cause the at least one processor to cause the agent interface to present the virtual environment including a user avatar associated with the user.

In a further enhancement, the computer-executable instructions may further cause the at least one processor to control a position and an orientation of the user avatar within the virtual environment based upon the user input data.

In another further enhancement, the computer-executable instructions may further cause the at least one processor to control a position and an orientation of the agent avatar within the virtual environment based upon agent input data received from the agent interface, the agent input data including one or more of live audio data, live video data, or live motion data.

In another enhancement, the computer-executable instructions may further cause the at least one processor to receive a plurality of data about the agent from a plurality of sources and generate a replicant persona of the agent based upon the plurality of data, wherein the replicant persona is configured to replicate one or more of mannerisms of the agent, appearance of the agent, personality of the agent, historical information relating to the agent, and conversational talking points of the agent, and wherein the proposed response is generated based at least in part upon the replicant persona.

In a further enhancement, the one or more mannerisms of the agent may include one or more of: hand gestures of the agent, facial gestures of the agent, body language of the agent, a speaking accent of the agent, a dialect of the agent, a personality of the agent, and/or emotions of the agent.

In another further enhancement, the plurality of data may include social media, behavior data from interviews, recordings, images, and/or historical data about the agent.

In another enhancement, the computer-executable instructions may further cause the at least one processor to execute one or more chatbots to generate the proposed response.

In another enhancement, the computer-executable instructions may further cause the at least one processor to record the user input data in the at least one memory device in association with a user profile.

In another enhancement, the computer-executable instructions may further cause the at least one processor to generate the virtual environment to include a plurality of defined locations to which the user is capable of navigating, each of the plurality of defined locations associated with a respective one or more agents.

In a further enhancement, the user input data may include speech, and the computer-executable instructions may further cause the at least one processor to, when the agent is present at the agent interface, translate the speech and cause the agent interface to present the translated speech within the virtual environment.

In another enhancement, the computer-executable instructions may further cause the at least one processor to generate the proposed response using an artificial intelligence model trained based upon historical interaction data.

In a further enhancement, the computer-executable instructions may further cause the at least one processor to train the artificial intelligence model using the historical interaction data.

In yet another aspect, a computer system for interaction with a plurality of users in a virtual environment may be provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT or ChatGPT-based bots, and/or other electronic or electrical components, which may be in wired or wireless communication with one another. For example, in one instance, the computer system may include at least one memory device and at least one processor in communication with the at least one memory device and one or more user devices. The at least one processor may be programmed to: (1) communicate with the one or more user devices to cause the one or more user devices to present the virtual environment, the virtual environment including at least one virtual lockbox associated with a first user of the plurality of users; (2) store one or more documents in the at least one memory device in association with the at least one virtual lockbox; (3) identify one or more authorized users of the plurality of users to enable access to the at least one virtual lockbox; and/or (4) provide access to the one or more documents in response to the identified one or more authorized users interacting with the virtual lockbox in the virtual environment. The computer system may have additional, less, or alternate functionality, including that discussed elsewhere herein.

In an enhancement, the at least one processor may be further configured to receive, from a mobile device associated with the user and configured to execute a mobile application, an instruction to store the one or more documents in associated with the at least one virtual lockbox and store the one or more documents in association with the at least one virtual lockbox in response to receiving the instruction.

In another enhancement, the at least one processor may be further configured to receive, from a first user device of the one or more user devices associated with a user, user input data indicating an intention to store the one or more documents in association with the at least one virtual lockbox and store the one or more documents in association with the at least one virtual lockbox in response to receiving the user input data.

In another enhancement, the at least one processor may be further configured to receive, from a mobile device associated with the user and configured to execute a mobile application, an instruction to designate the one or more authorized users as authorized to access the one or more documents and identify one or more authorized users based on the received instruction.

In another enhancement, the one or more documents may include one or more of an insurance policy document, an insurance card, or a document relating to an insurance claim.

In another enhancement, the one or more authorized users may include one or more of an insurance policyholder associated with the one or more documents, an insurance agent associated with the one or more documents, or an individual associated with an insurance claim relating to the one or more documents.

In another enhancement, the virtual environment may include at least one avatar associated with at least one of the plurality of users.

In a further enhancement, the at least one processor may be further configured to control a position and an orientation of the at least one avatar within the virtual environment based upon user input data received from a corresponding one of the one or more user devices.

In another aspect, a computer-implemented method for interaction with a plurality of users in a virtual environment may be provided may be provided. The computer-implemented method may be implemented via one or more local or remote processors, servers, transceivers, sensors, memory units, mobile devices, wearables, smart watches, smart contact lenses, smart glasses, augmented reality (AR) glasses, virtual reality (VR) headsets, mixed reality (MR) or extended reality glasses or headsets, voice bots or chatbots, ChatGPT or ChatGPT-based bots, and/or other electronic or electrical components, which may be in wired or wireless communication with one another. For example, in one instance, the computer-implemented method may be implemented by a computer system including at least one memory device and at least one processor in communication with the at least one memory device and one or more user devices. The method may include: (1) communicating with the one or more user devices to cause the one or more user devices to present the virtual environment, the virtual environment including at least one virtual lockbox associated with a first user of the plurality of users; (2) storing one or more documents in the at least one memory device in association with the at least one virtual lockbox; (3) identifying one or more authorized users of the plurality of users to enable access to the at least one virtual lockbox; and/or (4) providing access to the one or more documents in response to the identified one or more authorized users interacting with the virtual lockbox in the virtual environment. The method may include additional, less, or alternate actions, including those discussed elsewhere herein.

In an enhancement, the computer-implemented method may further include receiving, from a mobile device associated with the user and configured to execute a mobile application, an instruction to store the one or more documents in associated with the at least one virtual lockbox and storing the one or more documents in association with the at least one virtual lockbox in response to receiving the instruction.

In another enhancement, the computer-implemented method may further include receiving, from a first user device of the one or more user devices associated with a user, user input data indicating an intention to store the one or more documents in association with the at least one virtual lockbox and storing the one or more documents in association with the at least one virtual lockbox in response to receiving the user input data.

In another enhancement, the computer-implemented method may further include receiving, from a mobile device associated with the user and configured to execute a mobile application, an instruction to designate the one or more authorized users as authorized to access the one or more documents and identifying one or more authorized users based on the received instruction.

In another enhancement, the one or more documents may include one or more of an insurance policy document, an insurance card, or a document relating to an insurance claim.

In another enhancement, the one or more authorized users may include one or more of an insurance policyholder associated with the one or more documents, an insurance agent associated with the one or more documents, or an individual associated with an insurance claim relating to the one or more documents.

In another enhancement, the virtual environment may include at least one avatar associated with at least one of the plurality of users.

In a further enhancement, the computer-implemented method may further include controlling a position and an orientation of the at least one avatar within the virtual environment based upon user input data received from a corresponding one of the one or more user devices.

In yet another aspect, at least one non-transitory computer-readable media having computer-executable instructions embodied thereon may be provided. The computer-executable instructions may be executed by a computer system including at least one memory device and at least one processor and/or associated transceivers in communication with the at least one memory device and one or more user devices. The computer-executable instructions may direct or cause the at least one processor to: (1) communicate with the one or more user devices to cause the one or more user devices to present the virtual environment, the virtual environment including at least one virtual lockbox associated with a first user of the plurality of users; (2) store one or more documents in the at least one memory device in association with the at least one virtual lockbox; (3) identify one or more authorized users of the plurality of users to enable access to the at least one virtual lockbox; and/or (4) provide access to the one or more documents in response to the identified one or more authorized users interacting with the virtual lockbox in the virtual environment. The computer-executable instructions may direct additional, less, or alternate functionality, including that discussed elsewhere herein.

In an enhancement, the computer-executable instructions may further cause the at least one processor to receive, from a mobile device associated with the user and configured to execute a mobile application, an instruction to store the one or more documents in associated with the at least one virtual lockbox and store the one or more documents in association with the at least one virtual lockbox in response to receiving the instruction.

In another enhancement, the computer-executable instructions may further cause the at least one processor to receive, from a first user device of the one or more user devices associated with a user, user input data indicating an intention to store the one or more documents in association with the at least one virtual lockbox and store the one or more documents in association with the at least one virtual lockbox in response to receiving the user input data.

In another enhancement, the computer-executable instructions may further cause the at least one processor to receive, from a mobile device associated with the user and configured to execute a mobile application, an instruction to designate the one or more authorized users as authorized to access the one or more documents and identify one or more authorized users based on the received instruction.

In another enhancement, the one or more documents may include one or more of an insurance policy document, an insurance card, or a document relating to an insurance claim.

In another enhancement, the one or more authorized users may include one or more of an insurance policyholder associated with the one or more documents, an insurance agent associated with the one or more documents, or an individual associated with an insurance claim relating to the one or more documents.

In another enhancement, the virtual environment may include at least one avatar associated with at least one of the plurality of users.

In a further enhancement, the computer-executable instructions may further cause the at least one processor to control a position and an orientation of the at least one avatar within the virtual environment based upon user input data received from a corresponding one of the one or more user devices.

In yet another aspect, a computer system for interaction with a plurality of users in a virtual environment may be provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT or ChatGPT-based bots, and/or other electronic or electrical components, which may be in wired or wireless communication with one another. For example, in one instance, the computer system may include at least one memory device and at least one processor and/or associated transceiver in communication with the at least one memory device and one or more user devices. The at least one processor may be programmed to: (1) communicate with the one or more user devices to cause the one or more user devices to present the virtual environment; (2) receive sensor data from a first user device of the one or more user devices; (3) determine, based upon the received sensor data, that an accident has occurred; (4) in response to determining the accident has occurred, present, within the virtual environment to a first user using the first user device, one or more prompts for collecting information relating to the accident using the first user device; and/or (5) generate an accident profile including the information collected by the first user using the first user device in response to the one or more prompts. The computer system may have additional, less, or alternate functionality, including that discussed elsewhere herein.

In an enhancement, the at least one processor may be further configured to detect one or more voice commands input by the first user to the first user device.

In a further enhancement, at least one of the one or more voice commands may indicates the accident has occurred, and the at least one processor may be further configured to present the one or more prompts further in response to receiving the one or more voice commands.

In another further enhancement, the at least one of the one or more voice commands may request contact with an agent, and the at least one processor may be further configured to present, within the virtual environment to an agent using an agent device of the one or more user devices, a prompt to communicate with the first user within the virtual environment.

In another enhancement, the sensor data may include one or more of motion data, image data, or audio data.

In another enhancement, the at least one processor may be further configured to record one or more of a date, time, location, or weather associated with the accident within the accident profile.

In another enhancement, the one or more prompts may include one or more of prompts to capture images of a scene of the accident and/or prompts to record audio at the scene of the accident.

In another enhancement the first user device may be configured to detect one or more devices proximate to the first user device, and the at least one processor may be further configured to perform a lookup to identify individuals present at a scene of the accident based upon the detected one or more devices.

In another enhancement, the accident profile may include at least one digital twin representing a person, vehicle, or other object involved in the accident.

In another enhancement, the at least one processor may be further configured to generate a visual representation of the accident based upon the accident profile and present the visual representation to the one or more user devices within the virtual environment.

In another enhancement, the at least one processor may be further configured to determine that the accident has occurred using an artificial intelligence model trained based upon historical sensor data.

In a further enhancement, the at least one processor may be further configured to train the artificial intelligence model using the historical sensor data.

In yet another aspect, a computer-implemented method for interaction with a plurality of users in a virtual environment may be provided may be provided. The computer-implemented method may be implemented via one or more local or remote processors, servers, transceivers, sensors, memory units, mobile devices, wearables, smart watches, smart contact lenses, smart glasses, augmented reality (AR) glasses, virtual reality (VR) headsets, mixed reality (MR) or extended reality glasses or headsets, voice bots or chatbots, ChatGPT or ChatGPT-based bots, and/or other electronic or electrical components, which may be in wired or wireless communication with one another. For example, in one instance, the computer-implemented method may be implemented by a computer system including at least one memory device and at least one processor and/or associated transceiver in communication with the at least one memory device and one or more user devices. The method may include: (1) communicating with the one or more user devices to cause the one or more user devices to present the virtual environment; (2) receiving sensor data from a first user device of the one or more user devices; (3) determining, based upon the received sensor data, that an accident has occurred; (4) in response to determining the accident has occurred, presenting, within the virtual environment to a first user using the first user device, one or more prompts for collecting information relating to the accident using the first user device; and/or (5) generating an accident profile including the information collected by the first user using the first user device in response to the one or more prompts. The method may include additional, less, or alternate actions, including those discussed elsewhere herein.

In an enhancement, the computer-implemented method may further include detecting one or more voice commands input by the first user to the first user device.

In a further enhancement, at least one of the one or more voice commands may indicates the accident has occurred, and the computer-implemented method may further include presenting the one or more prompts further in response to receiving the one or more voice commands.

In another further enhancement, the at least one of the one or more voice commands may request contact with an agent, and the computer-implemented method may further include presenting, within the virtual environment to an agent using an agent device of the one or more user devices, a prompt to communicate with the first user within the virtual environment.

In another enhancement, the sensor data may include one or more of motion data, image data, or audio data.

In another enhancement, the computer-implemented method may further include recording one or more of a date, time, location, or weather associated with the accident within the accident profile.

In another enhancement, the one or more prompts may include one or more of prompts to capture images of a scene of the accident and/or prompts to record audio at the scene of the accident.

In another enhancement the first user device may be configured to detect one or more devices proximate to the first user device, and the computer-implemented method may further include performing a lookup to identify individuals present at a scene of the accident based upon the detected one or more devices.

In another enhancement, the accident profile may include at least one digital twin representing a person, vehicle, or other object involved in the accident.

In another enhancement, the computer-implemented method may further include generating a visual representation of the accident based upon the accident profile and presenting the visual representation to the one or more user devices within the virtual environment.

In another enhancement, the computer-implemented method may further include determining that the accident has occurred using an artificial intelligence model trained based upon historical sensor data.

In a further enhancement, the computer-implemented method may further include training the artificial intelligence model using the historical sensor data.

In yet another aspect, at least one non-transitory computer-readable media having computer-executable instructions embodied thereon may be provided. The computer-executable instructions may be executed by a computer system including at least one memory device and at least one processor and/or associated transceiver in communication with the at least one memory device and one or more user devices. The computer-executable instructions may direct or cause the at least one processor to: (1) communicate with the one or more user devices to cause the one or more user devices to present the virtual environment; (2) receive sensor data from a first user device of the one or more user devices; (3) determine, based upon the received sensor data, that an accident has occurred; (4) in response to determining the accident has occurred, present, within the virtual environment to a first user using the first user device, one or more prompts for collecting information relating to the accident using the first user device; and/or (5) generate an accident profile including the information collected by the first user using the first user device in response to the one or more prompts. The computer-executable instructions may direct additional, less, or alternate functionality, including that discussed elsewhere herein.

In an enhancement, the computer-executable instructions may further cause the at least one processor to detect one or more voice commands input by the first user to the first user device.

In a further enhancement, at least one of the one or more voice commands may indicates the accident has occurred, and the computer-executable instructions may further cause the at least one processor to present the one or more prompts further in response to receiving the one or more voice commands.

In another further enhancement, the at least one of the one or more voice commands may request contact with an agent, and the computer-executable instructions may further cause the at least one processor to present, within the virtual environment to an agent using an agent device of the one or more user devices, a prompt to communicate with the first user within the virtual environment.

In another enhancement, the sensor data may include one or more of motion data, image data, or audio data.

In another enhancement, the computer-executable instructions may further cause the at least one processor to record one or more of a date, time, location, or weather associated with the accident within the accident profile.

In another enhancement, the one or more prompts may include one or more of prompts to capture images of a scene of the accident and/or prompts to record audio at the scene of the accident.

In another enhancement the first user device may be configured to detect one or more devices proximate to the first user device, and the computer-executable instructions may further cause the at least one processor to perform a lookup to identify individuals present at a scene of the accident based upon the detected one or more devices.

In another enhancement, the accident profile may include at least one digital twin representing a person, vehicle, or other object involved in the accident.

In another enhancement, the computer-executable instructions may further cause the at least one processor to generate a visual representation of the accident based upon the accident profile and present the visual representation to the one or more user devices within the virtual environment.

In another enhancement, the computer-executable instructions may further cause the at least one processor to determine that the accident has occurred using an artificial intelligence model trained based upon historical sensor data.

In a further enhancement, the computer-executable instructions may further cause the at least one processor to train the artificial intelligence model using the historical sensor data.

### Machine Learning & Other Matters

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on vehicles or mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally, or alternatively, the machine learning programs may be trained by inputting sample data sets or certain data into the programs, such as image, mobile device, vehicle telematics, and/or intelligent home telematics data. The machine learning programs may utilize deep learning algorithms that may be primarily focused on pattern recognition and may be trained after processing multiple examples. The machine learning programs may include Bayesian program learning (BPL), voice recognition and synthesis, image or object recognition, optical character recognition, and/or natural language processing-either individually or in combination. The machine learning programs may also include natural language processing, semantic analysis, automatic reasoning, and/or machine learning.

In supervised machine learning, a processing element may be provided with example inputs and their associated outputs and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. In one embodiment, machine learning techniques may be used to extract the relevant personal belonging and/or home feature information for customers from mobile device sensors, vehicle-mounted sensors, home-mounted sensors, and/or other sensor data, vehicle or home telematics data, image data, and/or other data.

In one embodiment, a processing element may be trained by providing it with a large sample of conventional analog and/or digital, still and/or moving (i.e., video) image data, telematics data, and/or other data of belongings, household goods, durable goods, appliances, electronics, homes, etc. with known characteristics or features. Such information may include, for example, make or manufacturer and model information.

Based upon these analyses, the processing element may learn how to identify characteristics and patterns that may then be applied to analyzing sensor data, vehicle or home telematics data, image data, mobile device data, and/or other data. For example, the processing element may learn, with the customer's permission or affirmative consent, to identify the type and number of goods within the home, and/or purchasing patterns of the customer, such as by analysis of virtual receipts, customer virtual accounts with online or physical retailers, mobile device data, interconnected or smart home data, interconnected or smart vehicle data, etc. For the goods identified, a virtual inventory of personal items or personal articles may be maintained current and up to date. As a result, at the time of an event that damages the customer's home or goods, providing prompt and accurate service to the customer may be provided-such as accurate insurance claim handling, and prompt repair or replacement of damaged items for the customer.

In some embodiments, voice bots or chatbots, such as those discussed herein, may be configured to utilize AI and/or ML (machine learning) techniques. For instance, the chatbot may be a large language model such as OpenAI GPT-4, Meta LLaMa, or Google PaML 2. The voice bot or chatbot may employ supervised or unsupervised ML techniques, which may be followed by, and/or used in conjunction with, reinforced or reinforcement learning techniques. The voice bot or chatbot may employ the techniques utilized for ChatGPT.

### ADDITIONAL CONSIDERATIONS

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object-oriented databases, and any other structured or unstructured collection of records or data that is stored in a computer system. The above examples are not intended to limit in any way the definition and/or meaning of the term database. Examples of RDBMS's include, but are not limited to, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In another embodiment, a computer program is provided, and the program is embodied on a computer-readable medium. In one exemplary embodiment, the system is executed on a single computer system, without requiring a connection to a server computer. In a further exemplary embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process may be practiced independent and separate from other components and processes described herein. Each component and process may also be used in combination with other assembly packages and processes. The present embodiments may enhance the functionality and functioning of computers and/or computer systems.

As used herein, an element or action or operation recited in the singular and preceded by the word “a” or “an” should be understood as not excluding plural elements or action or operations, unless such exclusion is explicitly recited. Furthermore, references to “exemplary embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “action or operation for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A computer system for interaction with at least one user in a virtual environment, the computer system including at least one processor in communication with at least one memory device and in communication with a user device associated with a user and with an agent interface associated with an agent, the at least one processor configured to:
communicate with the user device to cause the user device to present the virtual environment, the virtual environment including at least one agent avatar associated with the agent;
receive, from the user device, user input data including one or more of live audio data, live video data, or live motion data;
generate a proposed response based upon the user input data;
determine whether an agent is present at the agent interface;
when the agent is present at the agent interface, cause the agent interface to display a recommendation including the proposed response; and
when the agent is not present at the agent interface, cause that at least one agent avatar to perform the proposed response within the virtual environment.

2. The computer system of claim 1, wherein the at least one processor is further configured to cause the agent interface to present the virtual environment including a user avatar associated with the user.

3. The computer system of claim 2, wherein the at least one processor is further configured to control a position and an orientation of the user avatar within the virtual environment based upon the user input data.

4. The computer system of claim 2, wherein the at least one processor is further configured to control a position and an orientation of the agent avatar within the virtual environment based upon agent input data received from the agent interface, the agent input data including one or more of live audio data, live video data, or live motion data.

5. The computer system of claim 1, wherein the at least one processor is further configured to:
receive a plurality of data about the agent from a plurality of sources; and
generate a replicant persona of the agent based upon the plurality of data, wherein the replicant persona is configured to replicate one or more of mannerisms of the agent, appearance of the agent, personality of the agent, historical information relating to the agent, and conversational talking points of the agent, and wherein the proposed response is generated based at least in part upon the replicant persona.

6. The computer system of claim 5, wherein the one or more mannerisms of the agent comprise one or more of: hand gestures of the agent, facial gestures of the agent, body language of the agent, a speaking accent of the agent, a dialect of the agent, a personality of the agent, and/or emotions of the agent.

7. The computer system of claim 5, wherein the plurality of data includes social media, behavior data from interviews, recordings, images, and/or historical data about the agent.

8. The computer system of claim 1, wherein the at least one processor is further configured to execute one or more chatbots to generate the proposed response.

9. The computer system of claim 1, wherein the at least one processor is further configured to record the user input data in the at least one memory device in association with a user profile.

10. The computer system of claim 1, wherein the at least one processor is further configured to generate the virtual environment to include a plurality of defined locations to which the user is capable of navigating, each of the plurality of defined locations associated with a respective one or more agents.

11. The computer system of claim 8, wherein the user input data includes speech, and wherein the at least one processor is configured to:
when the agent is present at the agent interface, translate the speech; and
cause the agent interface to present the translated speech within the virtual environment.

12. The computer system of claim 1, wherein the at least one processor is further configured to generate the proposed response using an artificial intelligence model trained based upon historical interaction data.

13. The computer system of claim 12, wherein the at least one processor is further configured to train the artificial intelligence model using the historical interaction data.

14. A computer-implemented method for interaction with at least one user in a virtual environment, the computer-implemented method performed by a computer system including at least one processor in communication with at least one memory device and in communication with a user device associated with a user and with an agent interface associated with an agent, the computer-implemented method comprising:
communicating with the user device to cause the user device to present the virtual environment, the virtual environment including at least one agent avatar associated with the agent;
receiving, from the user device, user input data including one or more of live audio data, live video data, or live motion data;
generating a proposed response based upon the user input data;
determining whether an agent is present at the agent interface;
when the agent is present at the agent interface, causing the agent interface to display a recommendation including the proposed response; and
when the agent is not present at the agent interface, causing that at least one agent avatar to perform the proposed response within the virtual environment.

15. The computer-implemented method of claim 14, further comprising causing the agent interface to present the virtual environment including a user avatar associated with the user.

16. The computer-implemented method of claim 15, further comprising controlling a position and an orientation of the user avatar within the virtual environment based upon the user input data.

17. The computer-implemented method of claim 15, further comprising controlling a position and an orientation of the agent avatar within the virtual environment based upon agent input data received from the agent interface, the agent input data including one or more of live audio data, live video data, or live motion data.

18. The computer-implemented method of claim 14, further comprising:
receiving a plurality of data about the agent from a plurality of sources; and
generating a replicant persona of the agent based upon the plurality of data, wherein the replicant persona is configured to replicate one or more of mannerisms of the agent, appearance of the agent, personality of the agent, historical information relating to the agent, and conversational talking points of the agent, and wherein the proposed response is generated based at least in part upon the replicant persona.

19. The computer-implemented method of claim 18, wherein the one or more mannerisms of the agent comprise one or more of: hand gestures of the agent, facial gestures of the agent, body language of the agent, a speaking accent of the agent, a dialect of the agent, a personality of the agent, and/or emotions of the agent.

20. At least one non-transitory computer-readable media having computer-executable instructions embodied thereon, wherein when executed by a computer system including at least one processor in communication with at least one memory device and in communication with a user device associated with a user and with an agent interface associated with an agent, the computer-executable instructions cause the at least one processor to:
communicate with the user device to cause the user device to present a virtual environment, the virtual environment including at least one agent avatar associated with the agent;
receive, from the user device, user input data including one or more of live audio data, live video data, or live motion data;
generate a proposed response based upon the user input data;
determine whether an agent is present at the agent interface;
when the agent is present at the agent interface, cause the agent interface to display a recommendation including the proposed response; and
when the agent is not present at the agent interface, cause that at least one agent avatar to perform the proposed response within the virtual environment.
